(19) United States
(12) Patent Application Publication
(10) Pub. No.: US 2026/0150080 A1
(43) Pub. Date: May 28, 2026

(54) COMMUNICATION METHODS AND FIRST NODE

(71) Applicant: GUANGDONG OPPO MOBILE TELECOMMUNICATIONS CORP., LTD., Dongguan (CN)

(72) Inventor: Yang LIU, Dongguan (CN)

(73) Assignee: GUANGDONG OPPO MOBILE TELECOMMUNICATIONS CORP., LTD., Dongguan (CN)

(21) Appl. No.: 19/449,049

(22) Filed: Jan. 14, 2026

Related U.S. Application Data
(63) Continuation of application No. PCT/CN2023/123425, filed on Oct. 8, 2023.

(51) Int. Cl. H04W 64/00; H04L 5/00

(52) U.S. Cl. CPC H04W 64/00; H04L 5/0051

(57) ABSTRACT

Disclosed are communication methods and a first node. The method includes: sending first information to a second node by means of a sidelink positioning protocol (SLPP), wherein the first information is related to the positioning integrity of a positioning system.

### CROSS-REFERENCE TO RELATED APPLICATION

This application is a continuation of International Patent Application No. PCT/CN2023/123425 filed on Oct. 8, 2023, disclosure of which is hereby incorporated by reference in its entirety.

### BACKGROUND ART

Positioning integrity is a measure of the trust level in the positioning information/positioning results provided by a positioning system. However, in existing Sidelink (SL) communication scenarios, applications related to positioning integrity are not yet supported.

### SUMMARY

Embodiments of the present disclosure relate to the field of communication technologies, and specifically, embodiments of the present disclosure provide communication methods, and first node.

According to a first aspect, an embodiment of the present disclosure provides a communication method, applied to a first node, the method including: transmitting first information to a second node via a Sidelink Positioning Protocol (SLPP), the first information being related to positioning integrity of a positioning system.

According to a second aspect, an embodiment of the present disclosure provides a communication method, applied to a second node, the method including: receiving first information from a first node via an SLPP, the first information being related to positioning integrity of a positioning system.

According to a third aspect, an embodiment of the present disclosure provides a first node, including: a processor and a memory, the memory being configured to store a computer program, the processor being configured to invoke and run the computer program stored in the memory to control the first node to perform operations of: transmitting first information to a second node via a Sidelink Positioning Protocol (SLPP), the first information being related to positioning integrity of a positioning system.

### BRIEF DESCRIPTION OF DRAWINGS

The accompanying drawings described herein are provided to further the understanding of the present disclosure and constitute a part of the present disclosure. The schematic embodiments of the present disclosure and their descriptions are intended to explain the present disclosure and do not constitute an improper limitation thereof. In the drawings:

FIG. 1 is a schematic diagram of an SL positioning process outside base station coverage provided by an embodiment of the present disclosure;

FIG. 2 is a schematic diagram of a message transmission process in a positioning session provided by an embodiment of the present disclosure;

FIG. 3 is a schematic flowchart of a communication method provided by an embodiment of the present disclosure;

FIG. 4 is a first schematic structural diagram of a communication apparatus provided by an embodiment of the present disclosure;

FIG. 5 is a second schematic structural diagram of a communication apparatus provided by an embodiment of the present disclosure;

FIG. 6 is a schematic structural diagram of a communication device provided by an embodiment of the present disclosure; and

FIG. 7 is a schematic structural diagram of a chip provided by an embodiment of the present disclosure.

### DETAILED DESCRIPTION OF EMBODIMENTS

Embodiments of the present disclosure will be described below in conjunction with the accompanying drawings. Obviously, the described embodiments are part of the embodiments of the present disclosure, not all of them. Based on the embodiments of the present disclosure, all other embodiments obtained by a person of ordinary skill in the art without creative effort shall fall within the protection scope of the present disclosure.

The technical solutions of the embodiments of the present disclosure can be applied to various sidelink communication systems. To facilitate understanding of the technical solutions of the embodiments of the present disclosure, related technologies of the embodiments of the present disclosure are described below. The following related technologies, as optional solutions, may be combined arbitrarily with the technical solutions of the embodiments of the present disclosure, all of which belong to the protection scope of the embodiments of the present disclosure.

### I. SL Positioning of UE-Only Operation

SL positioning of UE-only operation can also be understood as SL positioning performed by UEs without the participation of a core network and base stations.

Terminals in the embodiments of the present disclosure may be any terminal devices, including but not limited to terminal devices connected via wired or wireless connections to network devices or other terminal devices.

For example, the terminal device may refer to an access terminal, User Equipment (UE), user unit, user station, mobile station, mobile platform, remote station, remote terminal, mobile device, user terminal, terminal, wireless communication device, user agent, or user apparatus. The access terminal may be a cellular phone, cordless phone, Session Initiation Protocol (SIP) phone, Internet of Things (IoT) device, satellite handheld terminal, Wireless Local Loop (WLL) station, Personal Digital Assistant (PDA), handheld device with wireless communication capability, computing device, other processing device connected to a wireless modem, vehicle-mounted device, wearable device, terminal device in a 5th generation (5G) network, or terminal device in a future evolved network.

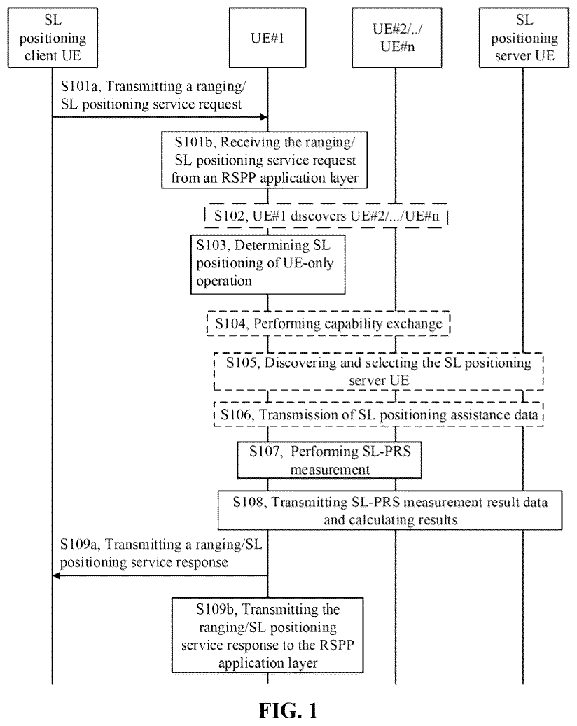

FIG. 1 is a schematic diagram of an SL positioning process outside base station coverage provided by an embodiment of the present disclosure. In FIG. 1, UE #1 is a Target UE, which refers to a UE being positioned during the SL positioning process in the embodiments of the present disclosure; UE #2 to UE #n are Anchor UEs, which refer to UEs assisting in positioning the Target UE during the SL positioning process in the embodiments of the present disclosure. Anchor UEs may also be called reference UEs.

As shown in FIG. 1, the SL positioning process may include:

S101a: The SL positioning client UE sends a ranging/SL positioning service request to UE #1.

The SL positioning client UE may send the ranging/SL positioning service request to UE #1 via a PC5 message. Correspondingly, UE #1 may receive the ranging/SL positioning service request from the SL positioning client UE via a PC5 message.

For absolute positioning, the ranging/SL positioning service request may include user information of the SL positioning client UE and user information of the Target UE, as well as the required positioning QoS.

For relative positioning or ranging information, the ranging/SL positioning service request may include user information of the SL positioning client UE, user information of the Target UE, user information of the Anchor UEs (UE #2/ . . . /UE #n), and ranging/SL positioning QoS information.

S101b: UE #1 receives the ranging/SL positioning service request from the Ranging and Sidelink Positioning Protocol (RSPP) application layer.

The ranging/SL positioning service request may include the type of result (e.g., absolute position, relative position, or ranging information) and the required QoS.

S102: UE #1 discovers UE #2/ . . . /UE #n.

If needed, UE #1 may discover Anchor UEs (UE #2/ . . . /UE #n).

S103: SL positioning of UE-only operation is determined.

If NG-RAN is not serving any of the Anchor UEs, or the serving network does not support ranging/SL positioning, then SL positioning of UE-only operation may be performed.

S104: capability exchange is performed.

UE #1 and the Anchor UEs (UE #2/ . . . /UE #n) perform capability exchange.

S105: Discovery and selection of the SL positioning server UE.

If UE #1 does not support the SL positioning server function, then discover and select an SL positioning server UE. If the SL positioning server UE is collocated with an Anchor UE or operated by another UE, UE #1 may discover and select this SL positioning server and request its participation in ranging/SL positioning.

S106: Transmission of SL positioning assistance data.

SL positioning assistance data is transmitted between UE #1/ . . . /UE #n and the SL positioning server UE.

S107: Perform SL-PRS measurements.

SL-PRS measurements may be performed between UE #1 and each Anchor UE. For example, SL-PRS measurements may be performed between UE #1 and UE #2; another example, SL-PRS measurements may be performed between UE #1 and UE #n.

S108: Transmission of SL-PRS measurement result data and result calculation.

The SL-PRS measurement result data may be transmitted to the SL positioning server UE, which performs the result calculation. Alternatively, if UE #1 supports the SL positioning server function, the SL-PRS measurement result data may be transmitted to UE #1, which performs the result calculation. The SL positioning server UE or UE #1 may calculate the absolute position, relative position, or ranging information of UE #1 based on the required result type.

S109a: UE #1 transmits a ranging/SL positioning service response to the SL positioning client UE.

UE #1 may transmit the ranging/SL positioning service response to the SL positioning client UE via a PC5 message, thereby transmitting the ranging/SL positioning result to the SL positioning client UE.

S109b: UE #1 transmits a ranging/SL positioning service response to the RSPP application layer.

UE #1 transmits the ranging/SL positioning result to the RSPP application layer by transmitting the ranging/SL positioning service response to the RSPP application layer.

### II. Related Concepts of Positioning Integrity

### 1 Positioning Integrity:

Positioning integrity is typically defined as: a measure of the trust in the correctness of the information provided by a positioning system for a specific application. The integrity of a positioning system includes the ability to timely indicate to the user the trustworthiness of the estimated position.

The above trustworthiness can be defined based on the Protection Level (PL) related to the positioning method. That is, PL is a key parameter for deriving positioning integrity results. By comparing the PL and the Alert Limit (AL), it can be determined whether the current positioning result of the positioning system meets the needs of positioning integrity. The value of AL can be determined by the Location Service (LCS) client or the application (APP) on the terminal itself.

### 2 Protection Level (PL)

PL can be calculated based on the expected behavior of error sources in the positioning system. The general definition of PL is as shown in the following formulas (1), (2), and (3):

$$PL = {K}_{md} {σ}_{PE} + B ; \qquad ( 1 )$$

$${K}_{md} = {Q}^{- 1} ( \frac{IR}{2} ) ; \qquad ( 2 )$$

$$Q = \frac{1}{\sqrt{2 π}} {\int }_{u}^{∞} {e}^{- {t}^{2} / 2} dt ; \qquad ( 3 )$$

where σ_{PE} is the standard deviation of the user position error at the receiver level; B is a bias term related to all possible biases included in the measurements. That is, σ_{PE} and B can be used to characterize the cumulative negative impact of numerous positioning error sources on the positioning result. The variance of a single measurement is as shown in formula (4):

$${σ}_{i}^{2} = {σ}_{A , i}^{2} + {σ}_{B , i}^{2} + {σ}_{C , i}^{2} + … ; \qquad ( 4 )$$

where

$${σ}_{i}^{2}$$

is the variance of a specific error source (depending on the NR positioning method) for the i-th Transmission and Reception Point (TRP). The Q function is the tail distribution function of the standard normal distribution. In other words, Q(t) is the probability that a normal (Gaussian) random variable obtains a value greater than/standard deviations.

IR in formula (2) represents Integrity Risk (IR). IR is defined as: the probability of providing information exceeding a specified tolerance (limit) without warning the user within a specified time period (the management of “warning” depends on the application). For example, for an IR of 10⁻⁷, K_{md}=5.33 It can be understood that a higher IR requirement, or in other words, a smaller IR value (e.g., 10⁻⁹), results in a higher K_{md} and thus a higher PL.

Typically, IR is determined based on the Target Integrity Risk (TIR), which can be provided as one of the positioning Key Performance Indicators (KPIs) from the positioning APP or LCS client to the 5G NR positioning system. The numerical definition of PL most likely limits the error of the positioning scheme. Therefore, the complementary probability (integrity risk) that the error in the positioning scheme exceeds its associated PL must be sufficiently small, not exceeding the TIR threshold for the specific application. PL is a real-time and dynamic quantity that may vary with the output period.

### 3 Error Sources in Uu-Based Positioning

To define the IR of a positioning system, it is necessary to understand the error sources (i.e., error sources), threat models, frequency of occurrence, and potential failure modes. Many threats can cause the positioning system (positioning service) to be unavailable. For NR positioning techniques, error sources may include:
(a) TRP location information (NR-TRP-LocationInfo);
(b) TRP time synchronization information (NR-RTD-Info);
(c) Beam aperture boresight direction (NR-DL-PRS-BeamInfo);
(d) Beam antenna information (NR-TRP-BeamAntennaInfo);
(e) UE/TRP local measurement errors. Such as Reference Signal Time Difference (RSTD), Relative Time of Arrival (RTOA), UE Rx-Tx time difference, gNB Rx-Tx time difference, Angle of Arrival (AoA), Reference Signal Receiving Power (RSRP)/Reference Signal Received Path Power (RSRPP) of Downlink Positioning Reference Signal (DL-PRS).

Based on the above error sources, it is necessary to convert this information into a form usable by the position calculation unit for deriving PL.

Among them, (a) to (d) above can be given in the assistance data; (e) is usually difficult to determine because this value is highly dependent on the implementation/algorithm used and the observation time for determining statistics is relatively short. For NR positioning techniques, it is generally assumed that the UE performs a single measurement/sampling. Clearly, it is impossible to determine any error statistics or probabilities from a single sample. Obviously, any error in beam aperture boresight direction or beam antenna information leads to errors in Downlink Angle of Departure (DL-AoD) positioning.

The role of beam aperture boresight direction/beam antenna information in DL-AoD positioning is similar to the role of Relative Time Discrepancy (RTD) in Downlink Time Difference of Arrival (DL-TDoA) positioning. In DL-TDoA position calculation, the measurement of each Time Difference of Arrival (TDOA) between two TRPs is associated with the difference in distances (or time of flight) from the two TRPs to the UE, and then these distances are used for calculation based on geometric relationships. This association assumes that the signals start their flight at exactly the same time; if not, the measured time difference will also reflect this lack of time alignment, which is unrelated to geometry and must be removed. RTD information precisely provides information on how to eliminate this lack of time alignment, therefore it is crucial for position calculation. Similar to how DL-TDoA compares Time of Arrival (TOA) measurements from different PRS (from different TRPs) to infer the distance difference to these TRPs, the DL-AoD method compares RSRP from different PRS (from the same TRP) to infer the Angle of Departure (AoD) through the TRP. Therefore, just as an uncorrected or incorrectly considered offset between the start of flight times of two PRS leads to error in TDoA and thus error in position, similarly, error in the boresight pointing angle of the transmit (Tx) beams of two PRS resources leads to error in the estimated DL-AoD.

For each positioning error source (or fault source), the assistance message can provide two types of Information Elements (IE). The first type of IE is the Do Not Use (DNU) Flag, and the second type of IE is the Integrity Bound and Residual Risk. The two types of IEs are described below.

### 4 DNU Flag

If an error source carries a DNU flag, it is considered that the error of that error source is too large, and therefore the corresponding assistance data should not be used for position calculation that guarantees positioning integrity. In other words, if the DNU flag is set to True, the UE should not use the corresponding assistance data for calculating integrity results, although this assistance data can still be used for positioning.

The reason for providing these DNU flags is that the UE must feel safe even when connection is lost. This means the UE must receive a positive signal (non-DNU, i.e., DNU set to False) indicating that the bound is still valid within the Time-to-Alert (TTA); otherwise, it must assume that a Feared Event may have occurred and no notification was delivered.

Point-to-Point provided NR assistance data does not have an explicit validity time. For broadcast assistance data (posSIB), an expiration time (also known as validity time) may be available.

Some assistance data is generally valid for a relatively long term, such as NR-TRP-LocationInfo or NR-DL-PRS-BeamInfo. Other assistance data may change frequently, such as NR-RTD-Info. But NR-DL-PRS-AssistanceData (DL-PRS configuration) may also change “suddenly” (e.g., in the case of on-demand DL-PRS). The UE can store available assistance data (which has not expired), which may come from broadcast or pre-configuration, for example.

Therefore, for integrity, it is important that when the error bound of a specific parameter is exceeded (or a parameter is no longer valid, e.g., due to a change in DL-PRS configuration), the UE receives an alert. If the network detects a feared event within a window between regular assistance data updates, the DNU flag will be set to “True”. DNU flags need to be provided frequently (according to TTA requirements) so that assistance data (e.g., obtained via broadcast or pre-configured) can be quickly invalidated. A DNU message (when set to False) is essentially a positive signal indicating that the bound is still valid within the TTA; otherwise, the UE assumes that a feared event may have occurred and no notification was delivered.

For Global Navigation Satellite System (GNSS), the granularity of DNU flags is currently as follows: per GNSS, per Space Vehicle (SV), per signal, per ionospheric correction, per tropospheric correction.

The use of DNU flags by GNSS ensures that the user discards satellites/assistance data that may be performing poorly. The same conclusion applies to NR positioning techniques. For example, if RTD information is unavailable (DNU), the UE may fall back to DL-AoD.

### 5 Integrity Bound and Residual Risk

To quantify PL, the network ensures that the probability of an unflagged event (i.e., DNU set to False, or non-DNU) where the error exceeds the corresponding bound is less than a specified threshold, as shown in formula (5):

$$P ( Integrity Failure Event ) = P ( Error > Bound \vert Non - DNU ) \leq Threshold ; \qquad ( 5 )$$

Formula (5) can usually be decomposed into fault and no-fault cases, as shown in formula (6):

$$P ( Integrity Failure Event ) = P ( Error > Bound \vert Non - DNU , Fault ) + P ( Error > Bound \vert Non - DNU , No Fault ) ; \qquad ( 6 )$$

For each of the above cases, a probability upper bound can be assigned, as shown in formulas (7) and (8):

$$P ( Error > Bound \vert Non - DNU , Fault ) \leq Residual Risk ; \qquad ( 7 )$$

$$P ( Error > Bound \vert Non - DNU , No Fault ) \leq {IR}_{allocation} ; \qquad ( 8 )$$

For all errors for which integrity assistance data is available and the corresponding DNU flag is set to False, the “Integrity Principle of Operation” can be obtained, as shown in formula (9):

$$P ( Error > Bound \vert Non - DNU ) \leq Residual Risk + {IR}_{allocation} ; \qquad ( 9 )$$

Formula (9) decomposes the risk into a fixed part provided in the assistance data (i.e., Residual Risk: the security risk that still exists after implementing security controls) and a variable part that scales with the bound (i.e., IR_{allocation}). The bound calculation formula is as shown in formulas (10), (11), and (12):

$$Bound = mean + K \times stdDev ; \qquad ( 10 )$$

$$K = normInv ( {IR}_{allocation} / 2 ) ; \qquad ( 11 )$$

$${ir}_{Minimum} \leq {IR}_{allocation} \leq {ir}_{Maximum} ; \qquad ( 12 )$$

where mean represents the mean of the error, stdDev represents the standard deviation of the error. IR_{allocation} can also be understood as the probability of error (i.e., error>bound) occurring when the system is fault-free. In the current protocol, IR_{allocation} can be arbitrarily selected by the system from the range from ir_{Minimum} to ir_{Maximum}, and then the bound value of the error source can be derived based on mean and stdDev. ir_{Minimum} and ir_{Maximum} represent the minimum and maximum integrity risks for which the bound parameters in the corresponding integrity assistance data are valid, respectively. They are sent by the network as integrity service parameters.

ir_{Minimum} and ir_{Maximum} should not be mistaken for integrity KPIs; they are attributes of the integrity assistance data itself (i.e., minimum/maximum validity) and are sent in the assistance data.

Currently, the residual risk is given by the Assistance Data. The residual risk at a certain point in time can be calculated from the following two items in the assistance data:
1) The probability of a fault (feared event) occurring per unit time;
2) The average duration of the fault (feared event).

For example, assume a one-hour time window and an event that may occur once per hour (occurrence probability) with an average duration of 30 minutes. Then, it can be expected that the event will occur once within the one-hour window. Therefore, the probability of this event being present at any given time is 30 minutes×1 occurrence/1 hour=0.5. If the average duration is only 6 minutes, then the probability of this event being present will be 0.1, although the occurrence probability has not changed.

### III. Messages Used in Positioning Session

FIG. 2 is a schematic diagram of a message transmission process in a positioning session provided by an embodiment of the present disclosure. As shown in FIG. 2, the message transmission process in a positioning session may include:

S201: Node #1 sends an SLPP RequestCapabilities message to Node #2.

S202: Node #2 sends an SLPP ProvideCapabilities message to Node #1.

S203: Node #2 sends an SLPP RequestAssistanceData message to Node #1.

S204: Node #1 sends an SLPP ProvideAssistanceData message to Node #2.

Here, the assistance data is used to provide Node #2 with auxiliary information for positioning, such as RTD, location information of Anchor UEs, beam angle information, etc.

S205: Node #1 sends an SLPP RequestLocationInformation message to Node #2.

Here, the SLPP RequestLocationInformation message can be used to request measurement results or positioning results. In other words, this process can be used to request the positioning signal measurement party to provide specific measurement results (such as TDOA/Round Trip Time (RTT)/AoA) or positioning results.

S206: Node #2 sends an SLPP ProvideLocationInformation message to Node #1.

Based on the above positioning integrity related concepts, positioning integrity is a measure of the trust level in the positioning information/positioning results provided by a positioning system. However, in existing SL communication scenarios, applications related to positioning integrity are not yet supported. In view of this, the present disclosure provides a communication method, apparatus, device, chip, and storage medium. This method transmits information related to positioning integrity via the SLPP, thereby achieving applications related to positioning integrity in SL scenarios.

To facilitate understanding of the technical solutions of the embodiments of the present disclosure, the technical solutions of the present disclosure are described in detail below through specific embodiments. The above related technologies, as optional solutions, may be arbitrarily combined with the technical solutions of the embodiments of the present disclosure, all of which belong to the protection scope of the embodiments of the present disclosure. The embodiments of the present disclosure include at least part of the following content.

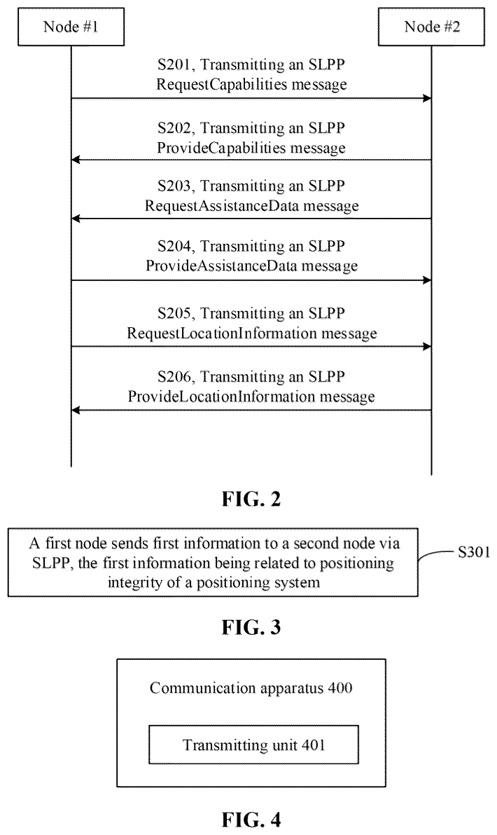

FIG. 3 is a schematic flowchart of a communication method provided by an embodiment of the present disclosure. As shown in FIG. 3, the method may include the following steps:

S301: A first node transmits first information to a second node via SLPP, the first information being related to positioning integrity of a positioning system.

Correspondingly, the second node may receive the first information from the first node via SLPP.

Here, the first node transmitting the first information to the second node via SLPP can also be understood as the first node transmitting the first information to the second node via SLPP signaling/an SLPP message/the SLPP protocol; the second node receiving the first information from the first node via SLPP can also be understood as the second node receiving the first information from the first node via SLPP signaling/an SLPP message/the SLPP protocol.

In a first scenario (denoted as Scenario #1), the first information may include at least one of:
A: At least one type of assistance information;
B: The range of IR values corresponding to the at least one type of assistance information;
C: The residual risk corresponding to the at least one type of assistance information;
D: Parameters for determining the residual risk corresponding to the at least one type of assistance information; or
E: a DNU flag associated with the at least one type of assistance information.

Items A to E are explained below.

A: At least one type of assistance information (or assistance data).

Exemplarily, all or part of the assistance information in this at least one type of assistance information can be used to determine the positioning integrity of the positioning system, or can be used for operations related to positioning integrity, or can be used to determine positioning integrity results. For example, all or part of the assistance information in this at least one type of assistance information can be used to calculate the PL of the positioning system, and the PL of the positioning system can be used to determine whether the positioning system meets integrity requirements.

In some embodiments, the first node is a first anchor terminal. The at least one type of assistance information may include, for example: a statistical value of the position error of the first anchor terminal; and/or a statistical value of the position error of the antenna reference point of the first anchor terminal. The statistical value may include at least one of: mean, variance, or standard deviation.

Here, the position error of the first anchor terminal can also be understood as the error (deviation) between the estimated position and the true position of the first anchor terminal; the position error of the antenna reference point of the first anchor terminal can also be understood as the error between the estimated position and the true position of the antenna reference point of the first anchor terminal.

In some embodiments, when the positioning method adopted by the positioning system is a Time Difference of Arrival based positioning method (e.g., SL-TDoA positioning method), the at least one type of assistance information may further include: a statistical value of the RTD error of the first anchor terminal; or a statistical value of the RTD error of the first anchor terminal relative to a second anchor terminal. The statistical value may include at least one of: mean, variance, or standard deviation.

Here, the RTD error of the first anchor terminal can also be understood as the RTD error of the first anchor terminal itself, or can also be understood as the error between the RTD estimated by the first anchor terminal and the true RTD; the RTD error of the first anchor terminal relative to the second anchor terminal can also be understood as the error between the RTD estimated by the first anchor terminal and the RTD of the second anchor terminal.

In one possible case, the first anchor terminal is a reference anchor terminal. Then, the at least one type of assistance information may include a statistical value of the RTD error of the first anchor terminal (reference anchor terminal) itself. In another possible case, the first anchor terminal is an anchor terminal other than the reference anchor terminal, and the second anchor terminal is the reference anchor terminal. Then, the at least one type of assistance information may include a statistical value of the RTD error of this first anchor terminal (non-reference anchor terminal) relative to the second anchor terminal (reference anchor terminal).

In some embodiments, when the positioning method adopted by the positioning system is an Angle of Departure based positioning method (e.g., SL-AoD positioning method), the at least one type of assistance information further includes: a statistical value of the beam angle error for the first anchor terminal transmitting SL-PRS and/or a statistical value of antenna beam information. The statistical value includes at least one of: mean, variance, or standard deviation. Here, the beam angle error for the first anchor terminal transmitting SL-PRS can also be understood as the deviation error of the beam angle for the first anchor terminal transmitting SL-PRS. In practical implementation, for example, the angle error of the beam bore-sight of the transmit beam can be used to represent the beam angle error for transmitting SL-PRS. The statistical value of antenna beam information can be, for example, a statistical value of error information of the antenna beam.

In some embodiments, when the positioning method adopted by the positioning system is an Angle of Arrival based positioning method (e.g., SL-AoA positioning method), the at least one type of assistance information further includes: a statistical value of the beam angle error for the first anchor terminal receiving SL-PRS and/or a statistical value of antenna beam information. The statistical value includes at least one of: mean, variance, or standard deviation. Here, the beam angle error for the first anchor terminal receiving SL-PRS can also be understood as the deviation error of the beam angle for the first anchor terminal receiving SL-PRS. In practical implementation, for example, the angle error of the beam bore-sight of the receive beam can be used to represent the beam angle error for receiving SL-PRS. The statistical value of antenna beam information can be, for example, a statistical value of error information of the antenna beam.

B: The range of IR values corresponding to the at least one type of assistance information.

Exemplarily, the range of IR values can be represented, for example, by a maximum IR (ir_{Minimum}) and a minimum IR (ir_{Maximum}). That is, the first information may carry the maximum IR and minimum IR corresponding to the at least one type of assistance information to represent the range of IR values corresponding to the at least one type of assistance information.

As an implementation, the range of IR values corresponding to all assistance information in the at least one type of assistance information is the same. For example, the maximum IR and minimum IR corresponding to all assistance information are the same, i.e., the IR corresponding to all assistance information falls between this maximum IR and this minimum IR. As another implementation, the ranges of IR values corresponding to different assistance information can be independent of each other, that is, the ranges of IR values corresponding to different assistance information may be the same or different.

Here, for each piece of assistance information, the range of IR values corresponding to that assistance information can be used, for example, to determine the IR corresponding to that assistance information. For example, for a certain piece of assistance information, a node for determining positioning integrity (e.g., a node calculating the PL of the positioning system) may select a value from the IR range corresponding to that assistance information as the IR corresponding to that assistance information. In some embodiments, the IR corresponding to each piece of assistance information can be used to determine the Achievable Integrity Risk of the positioning system, and/or can be used to determine the PL of the positioning system.

C: The residual risk corresponding to the at least one type of assistance information.

Here, the first information including the residual risk corresponding to the at least one type of assistance information can also be understood as the first information including the residual risk corresponding to each piece of assistance information in the at least one type of assistance information. In some embodiments, the residual risk corresponding to each piece of assistance information can be used to determine the achievable integrity risk of the positioning system.

D: Parameters for determining the residual risk corresponding to the at least one type of assistance information.

Here, the first information including parameters for determining the residual risk corresponding to the at least one type of assistance information can also be understood as the first information including parameters for determining the residual risk corresponding to each piece of assistance information in the at least one type of assistance information.

In some embodiments, after receiving the parameters for determining the residual risk corresponding to the at least one type of assistance information, the second node may determine the residual risk corresponding to each piece of assistance information based on these parameters. The residual risk corresponding to each piece of assistance information can be used to determine the achievable integrity risk of the positioning system.

In some embodiments, each piece of assistance information in the at least one type of assistance information may correspond to a first error source. For example, when the at least one type of assistance information includes a statistical value of the position error of the first anchor terminal, the first error source corresponding to this statistical value of the position error of the first anchor terminal can be considered as the position error of the first anchor terminal. For another example, when the at least one type of assistance information includes a statistical value of the RTD error of the first anchor terminal, the first error source corresponding to this statistical value of the RTD error of the first anchor terminal can be considered as the RTD error of the first anchor terminal.

Exemplarily, for any piece of assistance information in the at least one type of assistance information, assuming the first error source corresponding to this assistance information is Error Source A, then the parameters for determining the residual risk corresponding to this assistance information may include: the probability of occurrence per unit time of the Feared Event/Fault corresponding to this Error Source A, and the expected average duration of the Feared Event corresponding to this Error Source A. Therefore, the parameters for determining the residual risk corresponding to the at least one type of assistance information may include: the probability of occurrence per unit time of the Feared Event corresponding to each first error source (i.e., the first error source corresponding to each piece of assistance information), and the expected average duration of the Feared Event corresponding to each first error source.

E: A DNU Flag Associated with the at least one type of assistance information.

Here, the first information including a DNU flag associated with the at least one type of assistance information can also be understood as the first information including DNU flags associated with each piece of assistance information in the at least one type of assistance information.

In some embodiments, for any piece of assistance information in the at least one type of assistance information, when this assistance information cannot be used for applications related to positioning integrity, the DNU flag associated with this assistance information may be set to a true value, such as “1”, “True”, or “Positive”; when this assistance information can be used for applications related to positioning integrity, the DNU flag associated with this assistance information may be set to a false value, such as “0”, “False”, or “Negative”. In some embodiments, when the DNU flag associated with a certain piece of assistance information is set to a true value, that assistance information will not be used for operations related to positioning integrity, for example, will not be used to calculate the PL of the positioning system; when the DNU flag associated with a certain piece of assistance information is set to a false value, that assistance information can be used for operations related to positioning integrity, for example, can be used to calculate the PL of the positioning system.

According to the above technical solutions, the first node and the second node can transmit information related to assistance information for the positioning integrity scheme via SLPP, thereby enabling applications related to positioning integrity.

In one possible manner, the second node in Scenario #1 may be, for example, a node for determining positioning integrity/a node calculating PL/a node positioning the target terminal. As an example, the second node may be, for example, a Location Management Function (LMF) network element or a Location Server UE.

In some embodiments, the first information may further include at least one of:
F: Information on at least one type of positioning measurement result obtained by the first node measuring SL-PRS;
G: The range of IR values corresponding to the at least one type of positioning measurement result;
H: The residual risk corresponding to the at least one type of positioning measurement result;
I: Parameters for determining the residual risk corresponding to the at least one type of positioning measurement result; or
J: a DNU flag associated with the at least one type of positioning measurement result.

Items F to J are explained below.

F: Information on at least one type of positioning measurement result obtained by the First node measuring SL-PRS.

Exemplarily, all or part of the information of the at least one type of positioning measurement result can be used to determine positioning integrity, or can be used for operations related to positioning integrity, or can be used to determine positioning integrity results. For example, all or part of the information of the at least one type of positioning measurement result can be used to calculate the PL of the positioning system, and the PL of the positioning system can be used to determine whether the positioning system meets integrity requirements.

As examples, the at least one type of positioning measurement result may include but is not limited to at least one of: RSTD measurement result, RTD measurement result, or AoA measurement result.

In some embodiments, for each positioning measurement result in the at least one type of positioning measurement result, the information of that positioning measurement result may include, for example: a statistical value of the error of that positioning measurement result. In other words, the information of the at least one type of positioning measurement result may include: a statistical value of the error of each positioning measurement result in the at least one type of positioning measurement result. The statistical value may include at least one of: mean, variance, or standard deviation.

For example, assuming the at least one type of positioning measurement result includes an RSTD measurement result and an RTD measurement result, then the information of the at least one type of positioning measurement result may include: a statistical value of the error of the RSTD measurement result, and a statistical value of the error of the RTD measurement result.

G: The range of IR values corresponding to the at least one type of positioning measurement result.

Exemplarily, the range of IR values can be represented, for example, by a maximum IR (ir_{Minimum}) and a minimum IR (ir_{Maximum}). That is, the first information may carry the maximum IR and minimum IR corresponding to the at least one type of positioning measurement result to represent the range of IR values corresponding to the at least one type of positioning measurement result.

As an implementation, the range of IR values corresponding to all positioning measurement results in the at least one type of positioning measurement result is the same. For example, the maximum IR and minimum IR corresponding to all positioning measurement results are the same, i.e., the IR corresponding to all positioning measurement results falls between this maximum IR and this minimum IR. As another implementation, the ranges of IR values corresponding to different positioning measurement results can be independent of each other, that is, the ranges of IR values corresponding to different positioning measurement results may be the same or different.

Here, for each positioning measurement result, the range of IR values corresponding to that positioning measurement result can be used, for example, to determine the IR corresponding to that positioning measurement result. For example, for a certain positioning measurement result, a node for determining positioning integrity (e.g., a node calculating the PL of the positioning system) may select a value from the IR range corresponding to that positioning measurement result as the IR corresponding to that positioning measurement result. In some embodiments, the IR corresponding to each positioning measurement result can be used to determine the achievable integrity risk of the positioning system, and/or can be used to determine the PL of the positioning system.

H: The residual risk corresponding to the at least one type of positioning measurement result.

Here, the first information including the residual risk corresponding to the at least one type of positioning measurement result can also be understood as the first information including the residual risk corresponding to each positioning measurement result in the at least one type of positioning measurement result. In some embodiments, the residual risk corresponding to each positioning measurement result can be used to determine the achievable integrity risk of the positioning system.

I: Parameters for determining the residual risk corresponding to the at least one type of positioning measurement result.

Here, the first information including parameters for determining the residual risk corresponding to the at least one type of positioning measurement result can also be understood as the first information including parameters for determining the residual risk corresponding to each positioning measurement result in the at least one type of positioning measurement result.

In some embodiments, after receiving the parameters for determining the residual risk corresponding to the at least one type of positioning measurement result, the second node may determine the residual risk corresponding to each positioning measurement result based on these parameters. The residual risk corresponding to each positioning measurement result can be used to determine the achievable integrity risk of the positioning system.

In some embodiments, each positioning measurement result in the at least one type of positioning measurement result may correspond to a second error source. For example, when the at least one type of positioning measurement result includes an RSTD measurement result, the second error source corresponding to this RSTD measurement result can be considered as the RSTD measurement error; for another example, when the at least one type of positioning measurement result includes an RTD measurement result, the second error source corresponding to this RTD measurement result can be considered as the RTD measurement error.

Exemplarily, for any positioning measurement result in the at least one type of positioning measurement result, assuming the second error source corresponding to this positioning measurement result is Error Source B, then the parameters for determining the residual risk corresponding to this positioning measurement result may include: the probability of occurrence per unit time of the Feared Event corresponding to this Error Source B, and the expected average duration of the Feared Event corresponding to this Error Source B. Therefore, the parameters for determining the residual risk corresponding to the at least one type of positioning measurement result may include: the probability of occurrence per unit time of the Feared Event corresponding to each second error source (i.e., the second error source corresponding to each positioning measurement result), and the expected average duration of the Feared Event corresponding to each second error source.

J: A DNU flag associated with the at least one type of positioning measurement result.

Here, the first information including a DNU flag associated with the at least one type of positioning measurement result can also be understood as the first information including DNU flags associated with each positioning measurement result in the at least one type of positioning measurement result.

In some embodiments, for any positioning measurement result in the at least one type of positioning measurement result, when the information of this positioning measurement result cannot be used for applications related to positioning integrity, the DNU flag associated with this positioning measurement result may be set to a true value, such as “1”, “True”, or “Positive”; when the information of this positioning measurement result can be used for applications related to positioning integrity, the DNU flag associated with this positioning measurement result may be set to a false value, such as “0”, “False”, or “Negative”. In some embodiments, when the DNU flag associated with a certain positioning measurement result is set to a true value, the information of that positioning measurement result will not be used for operations related to positioning integrity, for example, will not be used to calculate the PL of the positioning system; when the DNU flag associated with a certain positioning measurement result is set to a false value, the information of that positioning measurement result can be used for operations related to positioning integrity, for example, can be used to calculate the PL of the positioning system.

According to the above technical solutions, the first node and the second node can transmit information related to positioning measurement results for the positioning integrity scheme via SLPP, thereby enabling applications related to positioning integrity.

In some embodiments, before transmitting the first information to the second node via the SLPP, the method may further include: the first node receiving the Time-to-Alert (TTA) of the positioning system via SLPP. The TTA can be used to determine: a DNU flag associated with the at least one type of assistance information; and/or a DNU flag associated with the at least one type of positioning measurement result; where the at least one type of positioning measurement result is obtained by the first node measuring SL-PRS.

Here, the TTA can be used to indicate: the maximum allowed time from when an error exceeds the corresponding bound to when the corresponding DNU flag is set to a true value.

In some embodiments, the TTA may be sent by the receiver of an LCS Service Request via SLPP. This TTA may be carried, for example, in the LCS Service Request. In one possible manner, the receiver of the LCS Service Request may be the second node. That is, before the second node receives the first information from the first node via SLPP, it may send the TTA of the positioning system to the first node via SLPP.

Correspondingly, before transmitting the first information to the second node via the SLPP, the first node may receive the TTA of the positioning system via SLPP. Subsequently, the first node may determine whether to set the DNU flag to a true or false value based on the received TTA. For example, after receiving the TTA, the first node may determine, based on the TTA, whether to set the DNU flags associated with the aforementioned at least one type of assistance information to a true or false value; for another example, after receiving the TTA, the first node may determine, based on the TTA, whether to set the DNU flags associated with the aforementioned at least one type of positioning measurement result to a true or false value.

In a second scenario (denoted as Scenario #2), the first information may include at least one of the following K to O:

K: Information on at least one type of positioning measurement result obtained by the first node measuring SL-PRS.

All or part of the information in this at least one type of positioning measurement result information is used to determine positioning integrity. Exemplarily, the information of the at least one type of positioning measurement result may include: a statistical value of the error of each positioning measurement result in the at least one type of positioning measurement result. The statistical value may include at least one of: mean, variance, or standard deviation.

L: The range of IR values corresponding to the at least one type of positioning measurement result.

M: The residual risk corresponding to the at least one type of positioning measurement result.

N: Parameters for determining the residual risk corresponding to the at least one type of positioning measurement result.

O: a DNU flag associated with the at least one type of positioning measurement result.

Descriptions of information K to O can be found, for example, in the descriptions of information F to J in Scenario #1. For brevity, details are not repeated here.

In one possible manner, the first node in Scenario #2 may be, for example, the measurer of SL-PRS (e.g., an anchor terminal; another example, the target terminal); the second node in Scenario #2 may be, for example, a node for determining positioning integrity/a node calculating PL/a node positioning the target terminal. As an example, the second node may be, for example, an LMF network element or a Location Server UE.

In some embodiments, each positioning measurement result in the at least one type of positioning measurement result corresponds to a second error source. For example, when the at least one type of positioning measurement result includes an RSTD measurement result, the second error source corresponding to this RSTD measurement result can be considered as the RSTD measurement error; for another example, when the at least one type of positioning measurement result includes an RTD measurement result, the second error source corresponding to this RTD measurement result can be considered as the RTD measurement error.

Exemplarily, for any positioning measurement result in the at least one type of positioning measurement result, assuming the second error source corresponding to this positioning measurement result is Error Source B, then the parameters for determining the residual risk corresponding to this positioning measurement result may include: the probability of occurrence per unit time of the Feared Event corresponding to this Error Source B, and the expected average duration of the Feared Event corresponding to this Error Source B. Therefore, the parameters for determining the residual risk corresponding to the at least one type of positioning measurement result may include: the probability of occurrence per unit time of the Feared Event corresponding to each second error source (i.e., the second error source corresponding to each positioning measurement result), and the expected average duration of the Feared Event corresponding to each second error source.

In some embodiments, for any positioning measurement result in the at least one type of positioning measurement result, when the information of this positioning measurement result cannot be used for applications related to positioning integrity, the DNU flag associated with this positioning measurement result may be set to a true value, such as “1”, “True”, or “Positive”; when the information of this positioning measurement result can be used for applications related to positioning integrity, the DNU flag associated with this positioning measurement result may be set to a false value, such as “0”, “False”, or “Negative”. In some embodiments, when the DNU flag associated with a certain positioning measurement result is set to a true value, the information of that positioning measurement result will not be used for operations related to positioning integrity, for example, will not be used to calculate the PL of the positioning system; when the DNU flag associated with a certain positioning measurement result is set to a false value, the information of that positioning measurement result can be used for operations related to positioning integrity, for example, can be used to calculate the PL of the positioning system.

According to the above technical solutions, the first node and the second node can transmit information related to positioning measurement results for the positioning integrity scheme via SLPP, thereby enabling applications related to positioning integrity.

In a third scenario (denoted as Scenario #3), the first information may include at least one of the following P to R related to positioning integrity Key Performance Indicators (KPIs):

P: The Target Integrity Risk (TIR) of the positioning system.

The TIR of the positioning system can also be understood as the TIR corresponding to the desired PL.

It can be understood that the achievable integrity risk of the positioning system should be as close as possible to the TIR of the positioning system. In some embodiments, by comparing the TIR of the positioning system with the achievable integrity risk of the positioning system, it can be determined whether the positioning result of the positioning system meets positioning integrity requirements.

Q: The Alert Limit (AL) of the positioning system.

The AL of the positioning system can be used to indicate: the maximum allowed positioning error without issuing a warning.

In some embodiments, the AL of the positioning system can be used to determine whether the positioning result of the positioning system meets positioning integrity requirements. For example, the AL of the positioning system can be compared with the PL of the positioning system, and based on the comparison result, it can be determined whether the positioning result of the positioning system meets positioning integrity requirements. For instance, when PL>AL, it can be considered that the positioning result of the positioning system does not meet positioning integrity requirements, or in other words, positioning integrity fails; when PL<AL, it can be considered that the positioning result of the positioning system meets positioning integrity requirements.

In some scenarios, the above “PL>AL” can be replaced with “PL≥AL”; in some scenarios, the above “PL<AL” can be replaced with “PL≤AL”.

R: The Time-to-Alert (TTA) of the positioning system.

The TTA of the positioning system can be used to indicate: the maximum allowed time from when an error exceeds the corresponding bound to when the corresponding DNU flag is set to a true value.

In some embodiments, the TTA can be used to determine: DNU flags associated with at least one type of assistance information (e.g., see information E in Scenario #1); and/or a DNU flag associated with at least one type of positioning measurement result (e.g., see information J in Scenario #1 or information O in Scenario #2).

In one possible manner, the first node may be, for example, the target terminal or the client terminal, and the second node may be, for example, the node determining positioning integrity. When the second node is the node determining positioning integrity (e.g., the node calculating PL), the first information may include: the TIR of the positioning system; and/or the AL of the positioning system. That is, the TIR and/or AL of the positioning system may be sent by the target terminal or client terminal and received by the node determining positioning integrity. In some embodiments, after receiving the TIR and/or AL of the positioning system, the node determining positioning integrity may determine whether the positioning result of the positioning system meets positioning integrity requirements based on the received TIR and/or AL.

In one possible manner, the first node may be, for example, the receiver of the LCS service request, and the second node may be, for example, the node determining DNU flags. When the second node is the node determining DNU flags, the first information may include: the TTA of the positioning system. That is, the TTA of the positioning system may be sent by the receiver of the LCS service request and received by the node determining DNU flags. In some embodiments, after receiving the TTA of the positioning system, the node determining DNU flags may determine whether to set DNU flags to a true or false value based on the received TTA. For example, based on the TTA, it may determine whether to set DNU flags associated with at least one type of assistance information to a true or false value; for another example, based on the TTA, it may determine whether to set a DNU flag associated with at least one type of positioning measurement result to a true or false value.

In one possible manner, the second node may be both the node determining positioning integrity and the node determining DNU flags. In this case, the second node may receive one or more of the following key performance indicators of the positioning system: TIR, AL, TTA.

According to the above technical solutions, the first node and the second node can transmit at least one key performance indicator related to positioning integrity via SLPP, thereby enabling applications related to positioning integrity.

In a fourth scenario (denoted as Scenario #4), the first information may include at least one of the following S to V positioning integrity results:

S: The Protection Level (PL) of the positioning system.

In some embodiments, the PL of the positioning system can be used to determine whether the positioning result of the positioning system meets positioning integrity requirements. For example, the AL of the positioning system can be compared with the PL of the positioning system, and based on the comparison result, it can be determined whether the positioning result of the positioning system meets positioning integrity requirements.

T: The achievable integrity risk of the positioning system.

The achievable integrity risk of the positioning system should be as close as possible to the TIR of the positioning system. In some embodiments, by comparing the TIR of the positioning system with the achievable integrity risk of the positioning system, it can be determined whether the positioning result of the positioning system meets positioning integrity requirements.

U: The comparison result between the PL of the positioning system and the AL of the positioning system.

This comparison result can be used to determine whether the positioning result of the positioning system meets positioning integrity requirements. For instance, when PL>AL, it can be considered that the positioning result of the positioning system does not meet positioning integrity requirements, or in other words, positioning integrity fails; when PL<AL, it can be considered that the positioning result of the positioning system meets positioning integrity requirements.

In some scenarios, the above “PL>AL” can be replaced with “PL>AL”; in some scenarios, the above “PL<AL” can be replaced with “PL≤AL”.

V: First indication information for indicating whether the positioning result of the positioning system meets positioning integrity requirements.

In one possible manner, the first node in Scenario #4 may be, for example, the node determining positioning integrity (or determining positioning integrity results). This first node can be used to determine at least one of the above positioning integrity results S to V. The second node may be, for example, an LMF network element or a Location Server UE.

In some embodiments, the first node may transmit the first information to the second node using a first mode or a second mode.

As an implementation, when the first node transmits the first information using the first mode, the first information may include: the PL of the positioning system, and/or the achievable integrity risk of the positioning system.

As another implementation, when the first node transmits the first information using the second mode, the first information may include at least one of the following: the comparison result between the PL of the positioning system and the AL of the positioning system; first indication information for indicating whether the positioning result of the positioning system meets positioning integrity requirements; or the achievable integrity risk of the positioning system.

In some embodiments, before transmitting the first information to the second node via the SLPP, the method may further include: the first node receiving second indication information from the second node, where the second indication information is used to instruct the first node to transmit the first information using the first mode or the second mode. That is, before the second node receives the first information from the first node via SLPP, the second node may send the second indication information to the first node to instruct the first node on the mode for transmitting the first information (e.g., first mode; another example, second mode). Subsequently, the first node may determine, based on the second indication information, to transmit the first information to the second node using the first mode or the second mode.

In some embodiments, when the PL of the positioning system is greater than the AL of the positioning system (or in other words, when the positioning result of the positioning system does not meet positioning integrity requirements), the first information includes: the comparison result between the PL of the positioning system and the AL of the positioning system and/or the first indication information. That is, this comparison result and/or first indication information may be transmitted from the first node to the second node when PL>AL (or when the positioning result of the positioning system does not meet positioning integrity requirements).

In some embodiments, when the PL of the positioning system is less than the AL of the positioning system (or in other words, when the positioning result of the positioning system meets positioning integrity requirements), the first information includes: the comparison result between the PL of the positioning system and the AL of the positioning system and/or the first indication information. That is, this comparison result and/or first indication information may be transmitted from the first node to the second node when PL<AL (or when the positioning result of the positioning system meets positioning integrity requirements).

In some embodiments, when the PL of the positioning system is less than the AL of the positioning system, or the PL of the positioning system is greater than the AL of the positioning system, the first information includes: the comparison result between the PL of the positioning system and the AL of the positioning system and/or the first indication information. That is, this comparison result and/or first indication information may be transmitted from the first node to the second node when PL<AL or PL>AL. In other words, for both the case of PL<AL and the case of PL>AL, the first information may include this comparison result and/or first indication information.

In some scenarios, the above “PL>AL” can be replaced with “PL≥AL”; in some scenarios, the above “PL<AL” can be replaced with “PL≤AL”.

According to the above technical solutions, the first node and the second node can transmit at least one positioning integrity result via SLPP, thereby enabling applications related to positioning integrity.

In some embodiments, before transmitting the first information to the second node via the SLPP, the method further includes: the first node receiving second information via SLPP, the second information being related to the PL of the positioning system.

In one possible manner, the second information may come from, for example, an anchor terminal and/or the target terminal. After receiving the second information, the first node may determine the PL of the positioning system based on all or part of the information in the second information.

Exemplarily, the second information may include: at least one type of assistance information; and/or information of at least one type of positioning measurement result obtained by measuring SL-PRS.

In Scenario #4, the at least one type of assistance information includes, for example: a statistical value of the position error of a first anchor terminal; and/or a statistical value of the position error of the antenna reference point of the first anchor terminal; where the statistical value includes at least one of: mean, variance, or standard deviation.

In some embodiments, when the positioning method adopted by the positioning system is a Time Difference of Arrival based positioning method, the at least one type of assistance information further includes: a statistical value of the Relative Time Difference (RTD) error of the first anchor terminal; or a statistical value of the RTD error of the first anchor terminal relative to a second anchor terminal; when the positioning method adopted by the positioning system is an Angle of Departure based positioning method, the at least one type of assistance information further includes: a statistical value of the beam angle error for the first anchor terminal transmitting Sidelink Positioning Reference Signal (SL-PRS) and/or a statistical value of antenna beam information; when the positioning method adopted by the positioning system is an Angle of Arrival based positioning method, the at least one type of assistance information further includes: a statistical value of the beam angle error for the first anchor terminal receiving SL-PRS and/or a statistical value of antenna beam information; where the statistical value includes at least one of: mean, variance, or standard deviation.

Other descriptions of the at least one type of assistance information can be found, for example, in the description of information A in Scenario #1, and are not repeated here.

In Scenario #4, the information of the at least one type of positioning measurement result may include: a statistical value of the error of each positioning measurement result in the at least one type of positioning measurement result; the statistical value includes at least one of: mean, variance, or standard deviation.

Other descriptions of the information of the at least one type of positioning measurement result can be found, for example, in the description of information F in Scenario #1, or in the description of information K in Scenario #2, and are not repeated here.

In some embodiments, before transmitting the first information to the second node via the SLPP, the method may further include: the first node receiving third information via SLPP, the third information being related to the achievable integrity risk of the positioning system.

In one possible manner, the third information may come from, for example, an anchor terminal and/or the target terminal. After receiving the third information, the first node may determine the achievable integrity risk of the positioning system based on all or part of the information in the third information.

Exemplarily, the third information may include at least one of the following: the range of IR values corresponding to at least one type of assistance information; the residual risk corresponding to the at least one type of assistance information; parameters for determining the residual risk corresponding to the at least one type of assistance information; the range of IR values corresponding to at least one type of positioning measurement result obtained by measuring SL-PRS; the residual risk corresponding to the at least one type of positioning measurement result; or parameters for determining the residual risk corresponding to the at least one type of positioning measurement result.

Other descriptions of the third information can be found, for example, in the descriptions of information B, C, D and information G, H, I in Scenario #1, and are not repeated here.

In some embodiments, before transmitting the first information to the second node via the SLPP, the method may further include: receiving fourth information via SLPP. The fourth information can be used to judge whether each piece of assistance information and/or positioning measurement result information can be used for operations related to positioning integrity (e.g., determining the PL of the positioning system).

In one possible manner, the fourth information may come from, for example, an anchor terminal and/or the target terminal. After receiving the fourth information, the first node may determine the achievable integrity risk of the positioning system based on all or part of the information in the fourth information.

Exemplarily, the fourth information may include: DNU flags associated with at least one type of assistance information (e.g., see information E in Scenario #1); and/or a DNU flag associated with at least one type of positioning measurement result (e.g., see information J in Scenario #1 or information O in Scenario #2), where the at least one type of positioning measurement result is obtained by measuring SL-PRS.

Here, for any piece of assistance information in the at least one type of assistance information, when the DNU flag associated with this assistance information is a false value, this assistance information can be used for operations related to positioning integrity, for example, can be used to determine the PL of the positioning system; correspondingly, when the DNU flag associated with this assistance information is a true value, this assistance information cannot be used for operations related to positioning integrity, for example, cannot be used to determine the PL of the positioning system.

For any positioning measurement result in the at least one type of positioning measurement result, when the DNU flag associated with this positioning measurement result is a false value, the information of this positioning measurement result can be used for operations related to positioning integrity, for example, can be used to determine the PL of the positioning system; correspondingly, when the DNU flag associated with this positioning measurement result is a true value, the information of this positioning measurement result cannot be used for operations related to positioning integrity, for example, cannot be used to determine the PL of the positioning system.

It should be noted that the above second information, third information, and fourth information may be carried, for example, in the same piece of SLPP signaling for transmission, or may be carried in multiple different pieces of SLPP signaling for transmission, which is not limited in the embodiments of the present disclosure.

In some embodiments, before transmitting the first information to the second node via the SLPP, the method may further include: receiving the AL of the positioning system via SLPP. The AL of the positioning system may come from, for example, the target terminal or the client terminal. In some embodiments, the AL of the positioning system can be used to determine whether the positioning result of the positioning system meets positioning integrity requirements. For example, the AL of the positioning system can be compared with the PL of the positioning system, and based on the comparison result, it can be determined whether the positioning result of the positioning system meets positioning integrity requirements.

In some embodiments, before transmitting the first information to the second node via the SLPP, the method may further include: receiving the TIR of the positioning system via SLPP. The TIR of the positioning system may come from, for example, the target terminal or the client terminal. In some embodiments, by comparing the TIR of the positioning system with the achievable integrity risk of the positioning system, it can be determined whether the positioning result of the positioning system meets positioning integrity requirements.

According to the method of the embodiments of the present disclosure, the first node and the second node can transmit information related to positioning integrity via SLPP, thereby achieving applications related to positioning integrity in SL scenarios.

It should be pointed out that similarities between Scenario #1 to Scenario #4 above can be cross-referenced. For example, explanations, roles of various information in Scenario #1 to Scenario #4, and transmission processes of various information can be cross-referenced.

The communication method provided by the embodiments of the present disclosure is described above. To facilitate understanding of the embodiments of the present disclosure, possible implementation solutions applicable to the communication method of the embodiments of the present disclosure are introduced below with examples.

Exemplarily, the solutions of the embodiments of the present disclosure may include:
Solution 1: Transmit assistance information related to positioning integrity required for SL positioning via SLPP;
Solution 2: Transmit information related to positioning integrity of positioning measurement results via SLPP;
Solution 3: Transmit SL positioning integrity KPIs via SLPP;
Solution 4: Transmit SL positioning integrity results via SLPP.

The above four solutions are introduced below.

### Solution 1

In Solution 1, assistance information related to positioning integrity required for SL positioning can be transmitted via SLPP.

Here, the assistance information related to integrity can be used, for example, to determine the integrity of the positioning system, or can be used for operations related to the positioning integrity of the positioning system. For example, all or part of the assistance information can be used to calculate the PL of the positioning system, and then based on the PL, it can be determined whether the current positioning result meets positioning integrity requirements.

Exemplarily, assistance information related to integrity can be transmitted via SLPP signaling (e.g., a Provide Assistance message). The assistance information may include, for example, general assistance information and method-specific assistance information.

In some embodiments, general assistance information may include, for example: location information of Anchor UEs. The location information of an Anchor UE may include, for example, at least one of: mean, variance, or standard deviation of the position error of the Anchor UE.

In some embodiments, general assistance information may further include, for example: location information of the antenna reference point of the Anchor UE. The location information of the antenna reference point of the Anchor UE may include, for example, at least one of: mean, variance, or standard deviation of the position error of the antenna reference point of the Anchor UE.

Method-specific assistance information is related to the positioning method adopted by the positioning system.

Example one: When the positioning method adopted by the positioning system is the SL-TDoA positioning method, the assistance information may include: RTD error information of the Anchor UE. In one possible case, the node transmitting the assistance information is a reference Anchor UE. Then, the assistance information may include at least one of: mean, variance, or standard deviation of the RTD error of the reference Anchor UE itself; in another possible case, the node transmitting the assistance information is an Anchor UE other than the reference Anchor UE. Then, the assistance information may include at least one of: mean, variance, or standard deviation of the RTD error of this other Anchor UE relative to the reference Anchor UE.

Example two: When the positioning method adopted by the positioning system is the SL-AoD positioning method, the assistance information may include at least one of: mean, variance, or standard deviation of the beam angle error (or beam angle deviation error) for transmitting SL-PRS. In practical implementation, it may be, for example, at least one of: mean, variance, or standard deviation of the angle error of the beam bore-sight of the transmit beam.

Example three: When the positioning method adopted by the positioning system is the SL-AoA positioning method, the assistance information may include at least one of: mean, variance, or standard deviation of the beam angle error (or beam angle deviation error) for receiving SL-PRS. In practical implementation, it may be, for example, at least one of: mean, variance, or standard deviation of the angle error of the beam bore-sight of the receive beam.

In some embodiments, the SLPP signaling used to transmit the assistance information may also carry, for example, the range of IR values corresponding to each piece of assistance information. For example, it may carry the maximum IR (ir_{Minimum}) and minimum IR (ir_{Maximum}) corresponding to each piece of assistance information.

As an implementation, the range of IR values corresponding to all assistance information is the same. For example, the maximum IR and minimum IR corresponding to all assistance information are the same, i.e., the IR corresponding to all assistance information falls between this maximum IR and this minimum IR. As another implementation, the ranges of IR values corresponding to different assistance information may be the same or different.

In some embodiments, the SLPP signaling used to transmit the assistance information may also carry, for example, the residual risk corresponding to each piece of assistance information, or may carry parameters for determining the residual risk corresponding to each piece of assistance information.

As an implementation, the SLPP signaling used to transmit the assistance information may carry the residual risk corresponding to each piece of assistance information. For example, assuming the assistance information includes the location information of an Anchor UE and the RTD error information of the Anchor UE, then the SLPP signaling used to transmit the assistance information may carry: the residual risk corresponding to the location information of the Anchor UE, and the residual risk corresponding to the RTD error information of the Anchor UE.

As another implementation, the SLPP signaling used to transmit the assistance information may carry parameters for determining the residual risk corresponding to each piece of assistance information. Exemplarily, for a certain piece of assistance information, assuming the error source corresponding to this assistance information is Error Source A, then the parameters for determining the residual risk corresponding to this assistance information may include: the probability of occurrence per unit time of the Feared Event corresponding to this Error Source A, and the expected average duration of the Feared Event corresponding to this Error Source A.

In some embodiments, for any piece of assistance information among the above assistance information, when this assistance information cannot be used for applications related to positioning integrity, the DNU flag associated with this assistance information may be set to a true value, such as “1”, “True”, or “Positive”. When this assistance information cannot be used for applications related to positioning integrity, the DNU flag associated with this assistance information may be set to a false value, such as “0”, “False”, or “Negative”.

### Solution 2

In Solution 2, information related to positioning integrity of positioning measurement results can be transmitted via SLPP.

Here, the information related to integrity of positioning measurement results can be used, for example, to determine the integrity of the positioning system, or can be used for operations related to the positioning integrity of the positioning system. For example, all or part of the information in the positioning measurement result information can be used to calculate the PL of the positioning system, and then based on the PL, it can be determined whether the current positioning result meets positioning integrity requirements.

Exemplarily, positioning measurement results may include but are not limited to at least one of the following: RSTD measurement results, RTD measurement results, or AoA measurement results. For each positioning measurement result, the positioning measurement result information may include, for example, at least one of: mean, variance, or standard deviation of the error of the positioning measurement result. For example, when the positioning measurement results include RSTD measurement results, the RSTD measurement result information may include at least one of: mean, variance, or standard deviation of the error of the RSTD measurement result; for another example, when the positioning measurement results include RTD measurement results, the RTD measurement result information may include at least one of: mean, variance, or standard deviation of the error of the RTD measurement result.

Currently, RAN2 stipulates that in Uu positioning, the integrity parameters of related positioning measurement results are derived by the LMF network element based on its own implementation and by synthesizing measurement quantities received at different times. In the embodiments of the present disclosure, the information related to positioning integrity of positioning measurement results may be carried, for example, in SLPP signaling (e.g., an SLPP ProvideLocationMeasurement message), sent by the measurer of SL-PRS (e.g., an Anchor UE; another example, the Target UE) to the LMF network element or Location Server UE.

In some embodiments, the SLPP signaling used to transmit the positioning measurement result information may also carry, for example, the range of IR values corresponding to each positioning measurement result. For example, it may carry the maximum IR (ir_{Minimum}) and minimum IR (ir_{Maximum}) corresponding to each positioning measurement result.

As an implementation, the range of IR values corresponding to all positioning measurement results is the same. For example, the maximum IR and minimum IR corresponding to all positioning measurement results are the same, i.e., the IR corresponding to all positioning measurement results falls between this maximum IR and this minimum IR. As another implementation, the ranges of IR values corresponding to different positioning measurement results may be the same or different.

In some embodiments, the SLPP signaling used to transmit the positioning measurement result information may also carry, for example, the residual risk corresponding to each positioning measurement result, or may carry parameters for determining the residual risk corresponding to each positioning measurement result.

As an implementation, the SLPP signaling used to transmit the positioning measurement result information may carry the residual risk corresponding to each positioning measurement result. For example, assuming the positioning measurement results include RSTD measurement results and RTD measurement results, then the SLPP signaling used to transmit the positioning measurement result information may carry: the residual risk corresponding to the RSTD measurement results, and the residual risk corresponding to the RTD measurement results.

As another implementation, the SLPP signaling used to transmit the positioning measurement result information may carry parameters for determining the residual risk corresponding to each positioning measurement result. Exemplarily, for a certain positioning measurement result, assuming the error source corresponding to this positioning measurement result is Error Source B, then the parameters for determining the residual risk corresponding to this positioning measurement result may include: the probability of occurrence per unit time of the Feared Event corresponding to this Error Source B, and the expected average duration of the Feared Event corresponding to this Error Source B.

### Solution 3

In Solution 3, SL positioning integrity KPI can be transmitted via SLPP.

Exemplarily, positioning integrity KPI may include at least one of: TIR, TTA, or AL.

Here, TIR is used to indicate: the TIR corresponding to the desired PL; TTA is used to indicate: the maximum allowed time from when an error exceeds the corresponding bound to when the corresponding DNU flag is set to a true value. AL is used to indicate: the maximum allowed positioning error without issuing a warning.

In some embodiments, TIR may be sent by the Target UE or Client UE and received by the node positioning the Target UE/the node determining positioning integrity/the node calculating PL.

In some embodiments, TTA may be sent by the receiver of the LCS Service Request and received by each terminal that decides whether to set DNU to a true or false value. For example, it may be received by each terminal that decides whether the DNU associated with assistance information is set to a true or false value, and/or by each terminal that decides whether the DNU associated with a positioning measurement result is set to a true or false value.

In some embodiments, AL may be sent by the Target UE or Client UE and received by the node positioning the Target UE/the node determining positioning integrity/the node calculating PL. In one possible case, the node calculating PL and the receiver of the LCS Service Request may be the same node; in another possible case, the node calculating PL and the receiver of the LCS Service Request are different nodes. In that case, the AL needs to be sent to the final node calculating PL via the SLPP protocol.

### Solution 4

In Solution 4, SL positioning integrity results can be transmitted via SLPP.

Here, positioning integrity results may include at least one of the following: PL, achievable integrity risk, comparison result between PL and AL, or first indication information for indicating whether the current positioning result meets positioning integrity requirements.

Exemplarily, positioning integrity results may be reported, for example, by the node calculating PL to the LMF network element or Location Server UE.

As an implementation, when the LMF network element or Location Server UE instructs the node calculating PL to report positioning integrity results using Mode 1, after calculating the PL, the node calculating PL may transmit the PL and/or the achievable integrity risk to the LMF network element or Location Server UE via SLPP signaling (e.g., an SLPP ProvideLocationInformation message).

As another implementation, when the LMF network element or Location Server UE instructs the node calculating PL to report positioning integrity results using Mode 2, after calculating the PL, the node calculating PL may transmit the comparison result between the PL and AL (e.g., PL>AL; another example, PL<AL) and/or the achievable integrity risk to the LMF network element or Location Server UE via SLPP signaling (e.g., an SLPP ProvideLocationInformation message), or transmit the first indication information and/or the achievable integrity risk to the LMF network element or Location Server UE.

Exemplarily, if PL>AL, it can be considered that the current positioning result does not meet positioning integrity requirements, or in other words, positioning integrity fails; if PL<AL, it can be considered that the current positioning result meets positioning integrity requirements.

As an implementation, in the case of PL>AL (or when the current positioning result does not meet positioning integrity requirements), the positioning integrity result may include: the comparison result between PL and AL and/or the first indication information. That is, the comparison result between PL and AL and/or the first indication information may be reported by the node calculating PL in the case of PL>AL (or when the current positioning result does not meet positioning integrity requirements).

As another implementation, in the case of PL<AL (or when the current positioning result meets positioning integrity requirements), the positioning integrity result may include: the comparison result between PL and AL and/or the first indication information. That is, the comparison result between PL and AL and/or the first indication information may be reported by the node calculating PL in the case of PL<AL (or when the current positioning result meets positioning integrity requirements).

As yet another implementation, in the case of PL<AL or PL>AL, the positioning integrity result may include: the comparison result between PL and AL and/or the first indication information. That is, the comparison result between PL and AL and/or the first indication information may be reported by the node calculating PL in the case of PL<AL or PL>AL. In other words, for both the case of PL<AL and the case of PL>AL, the positioning integrity result may include the comparison result between PL and AL and/or the first indication information.

In some scenarios, the above “PL>AL” can be replaced with “PL>AL”; in some scenarios, the above “PL<AL” can be replaced with “PL≤AL”.

Based on the foregoing embodiments, the present disclosure embodiment provides a corresponding communication apparatus.

FIG. 4 is a first schematic structural diagram of a communication apparatus provided by an embodiment of the present disclosure, applied to a first node. As shown in FIG. 4, the communication apparatus 400 (hereinafter abbreviated as apparatus 400) includes:

A transmitting unit 401, configured to transmit first information to a second node via an SLPP, the first information being related to positioning integrity of a positioning system.

In some embodiments, the first information includes at least one of: at least one type of assistance information, wherein all or part of the at least one type of assistance information is used to determine the positioning integrity; a range of a value of Integrity Risk (IR) corresponding to the at least one type of assistance information; a residual risk corresponding to the at least one type of assistance information; parameters for determining the residual risk corresponding to the at least one type of assistance information; or a DNU flag associated with the at least one type of assistance information.

In some embodiments, the apparatus 400 is a first anchor terminal, and the at least one type of assistance information includes: a statistical value of a position error of the first anchor terminal; and/or a statistical value of a position error of an antenna reference point of the first anchor terminal; wherein the statistical value includes at least one of: mean, variance, or standard deviation.

In some embodiments, when the positioning method adopted by the positioning system is a Time Difference of Arrival based positioning method, the at least one type of assistance information further includes: a statistical value of a Relative Time Difference (RTD) error of the first anchor terminal; or a statistical value of an RTD error of the first anchor terminal relative to a second anchor terminal; when the positioning method adopted by the positioning system is an Angle of Departure based positioning method, the at least one type of assistance information further includes: a statistical value of a beam angle error and/or a statistical value of antenna beam information for the first anchor terminal transmitting a Sidelink Positioning Reference Signal (SL-PRS); when the positioning method adopted by the positioning system is an Angle of Arrival based positioning method, the at least one type of assistance information further includes: a statistical value of a beam angle error and/or a statistical value of antenna beam information for the first anchor terminal receiving the SL-PRS; wherein the statistical value includes at least one of: mean, variance, or standard deviation.

In some embodiments, each piece of assistance information in the at least one type of assistance information corresponds to a first error source; the parameters for determining the residual risk corresponding to the at least one type of assistance information include: a probability of occurrence per unit time of a Feared Event corresponding to each first error source, and an expected average duration of the Feared Event corresponding to each first error source.

In some embodiments, for any piece of assistance information in the at least one type of assistance information, when the piece of assistance information cannot be used for applications related to the positioning integrity, the DNU flag associated with the piece of assistance information is set to a true value; when the piece of assistance information can be used for applications related to the positioning integrity, the DNU flag associated with the piece of assistance information is set to a false value.

In some embodiments, the first information further includes at least one of: information of at least one type of positioning measurement result obtained by the apparatus 400 measuring SL-PRS, wherein all or part of the information of the at least one type of positioning measurement result is used to determine the positioning integrity; a range of a value of IR corresponding to the at least one type of positioning measurement result; a residual risk corresponding to the at least one type of positioning measurement result; parameters for determining the residual risk corresponding to the at least one type of positioning measurement result; or a DNU flag associated with the at least one type of positioning measurement result.

In some embodiments, the apparatus 400 further includes: a first receiving unit, configured to, before transmitting the first information to the second node via the SLPP, receive a Time-to-Alert (TTA) of the positioning system via SLPP, the TTA being used to determine: a DNU flag associated with the at least one type of assistance information; and/or a DNU flag associated with at least one type of positioning measurement result; wherein the at least one type of positioning measurement result is obtained by the apparatus 400 measuring SL-PRS.

In some embodiments, the first information includes at least one of: information of at least one type of positioning measurement result obtained by a first node measuring SL-PRS, wherein all or part of the information of the at least one type of positioning measurement result is used to determine the positioning integrity; a range of a value of IR corresponding to the at least one type of positioning measurement result; a residual risk corresponding to the at least one type of positioning measurement result; parameters for determining the residual risk corresponding to the at least one type of positioning measurement result; or a DNU flag associated with the at least one type of positioning measurement result.

In some embodiments, each positioning measurement result in the at least one type of positioning measurement result corresponds to a second error source; the parameters for determining the residual risk corresponding to the at least one type of positioning measurement result include: a probability of occurrence per unit time of a Feared Event corresponding to each second error source, and an expected average duration of the Feared Event corresponding to each second error source.

In some embodiments, for any positioning measurement result in the at least one type of positioning measurement result, when the information of the positioning measurement result cannot be used for applications related to the positioning integrity, the DNU flag associated with the positioning measurement result is set to a true value; when the information of the positioning measurement result can be used for applications related to the positioning integrity, the DNU flag associated with the positioning measurement result is set to a false value.

In some embodiments, the first information includes at least one key performance indicator related to the positioning integrity: a Target Integrity Risk (TIR) of the positioning system; an Alert Limit (AL) of the positioning system; and a Time-to-Alert (TTA) of the positioning system.

In some embodiments, when the second node is a node for determining the positioning integrity, the first information includes: the TIR of the positioning system; and/or the AL of the positioning system; when the second node is a node for determining a DNU flag, the first information includes: the TTA of the positioning system.

In some embodiments, the second node is a Location Management Function network element or a Location Server UE, and the first information includes at least one of: a Protection Level (PL) of the positioning system; an achievable integrity risk of the positioning system; a comparison result between the PL of the positioning system and the AL of the positioning system, the comparison result being used to determine whether a positioning result of the positioning system meets positioning integrity requirements; or first indication information for indicating whether the positioning result of the positioning system meets positioning integrity requirements.

In some embodiments, the second node is a Location Management Function network element or a Location Server UE, when the first node transmits the first information using a first mode, the first information includes: the PL of the positioning system, and/or the achievable integrity risk of the positioning system; when the first node transmits the first information using a second mode, the first information includes at least one of: the comparison result between the PL of the positioning system and the AL of the positioning system; the first indication information for indicating whether the positioning result of the positioning system meets positioning integrity requirements; or the achievable integrity risk of the positioning system.

In some embodiments, the apparatus 400 further includes: a second receiving unit, configured to, before transmitting the first information to the second node via the SLPP, receive second indication information from the second node, the second indication information being used to instruct the first node to transmit the first information using the first mode or the second mode.

In some embodiments, when the PL of the positioning system is greater than the AL of the positioning system, the first information includes the comparison result and/or the first indication information; when the PL of the positioning system is less than the AL of the positioning system, the first information includes the comparison result and/or the first indication information; when the PL of the positioning system is less than the AL of the positioning system, or the PL of the positioning system is greater than the AL of the positioning system, the first information includes the comparison result and/or the first indication information.

In some embodiments, the apparatus 400 further includes: a third receiving unit, configured to, before transmitting the first information to the second node via the SLPP, receive second information via SLPP, the second information being related to the PL of the positioning system; the second information includes: at least one type of assistance information; and/or information of at least one type of positioning measurement result obtained by measuring SL-PRS.

In some embodiments, the apparatus 400 further includes: a fourth receiving unit, configured to, before transmitting the first information to the second node via the SLPP, receive third information via SLPP, the third information being related to the achievable integrity risk of the positioning system; the third information includes at least one of: a range of a value of IR corresponding to at least one type of assistance information; a residual risk corresponding to the at least one type of assistance information; parameters for determining the residual risk corresponding to the at least one type of assistance information; a range of a value of IR corresponding to at least one type of positioning measurement result obtained by measuring SL-PRS; a residual risk corresponding to the at least one type of positioning measurement result; or parameters for determining the residual risk corresponding to the at least one type of positioning measurement result.

In some embodiments, the apparatus 400 further includes: a fifth receiving unit, configured to, before transmitting the first information to the second node via the SLPP, receive fourth information via SLPP, the fourth information including: DNU flags associated with at least one type of assistance information; and/or a DNU flag associated with at least one type of positioning measurement result, the at least one type of positioning measurement result being obtained by measuring SL-PRS; for any piece of assistance information in the at least one type of assistance information, when the DNU flag associated with the assistance information is a false value, the assistance information is used to determine the PL of the positioning system; for any positioning measurement result in the at least one type of positioning measurement result, when the DNU flag associated with the positioning measurement result is a false value, the information of the positioning measurement result is used to determine the PL of the positioning system.

In some embodiments, the at least one type of assistance information includes: a statistical value of a position error of a first anchor terminal; and/or a statistical value of a position error of an antenna reference point of the first anchor terminal; wherein the statistical value includes at least one of: mean, variance, or standard deviation.

In some embodiments, when the positioning method adopted by the positioning system is a Time Difference of Arrival based positioning method, the at least one type of assistance information further includes: a statistical value of a Relative Time Difference (RTD) error of the first anchor terminal; or a statistical value of an RTD error of the first anchor terminal relative to a second anchor terminal; when the positioning method adopted by the positioning system is an Angle of Departure based positioning method, the at least one type of assistance information further includes: a statistical value of a beam angle error and/or a statistical value of antenna beam information for the first anchor terminal transmitting a Sidelink Positioning Reference Signal (SL-PRS); when the positioning method adopted by the positioning system is an Angle of Arrival based positioning method, the at least one type of assistance information further includes: a statistical value of a beam angle error and/or a statistical value of antenna beam information for the first anchor terminal receiving the SL-PRS; wherein the statistical value includes at least one of: mean, variance, or standard deviation.

In some embodiments, the information of the at least one type of positioning measurement result includes: a statistical value of an error of each positioning measurement result in the at least one type of positioning measurement result; the statistical value includes at least one of: mean, variance, or standard deviation.

In some embodiments, the apparatus 400 further includes: a sixth receiving unit, configured to, before transmitting the first information to the second node via the SLPP, receive the AL of the positioning system via SLPP, the AL of the positioning system being used to determine whether a positioning result of the positioning system meets positioning integrity requirements.

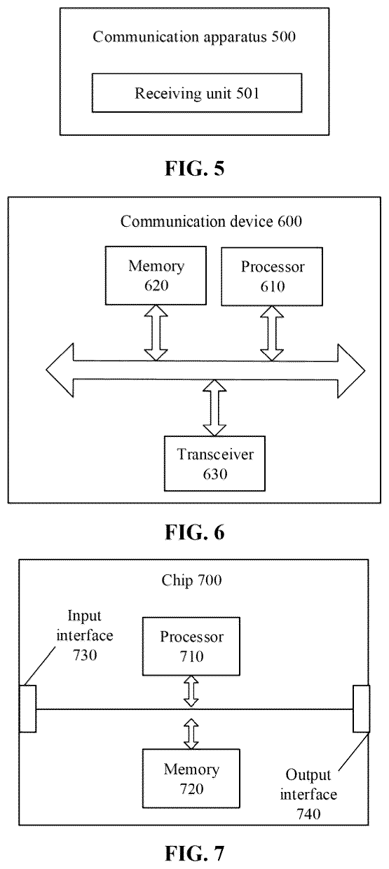

FIG. 5 is a second schematic structural diagram of a communication apparatus provided by an embodiment of the present disclosure, applied to a second node. As shown in FIG. 5, the communication apparatus 500 (hereinafter abbreviated as apparatus 500) includes:

A receiving unit 501, configured to receive first information from a first node via an SLPP, the first information being related to positioning integrity of a positioning system.

In some embodiments, the first information includes at least one of: at least one type of assistance information, wherein all or part of the at least one type of assistance information is used to determine the positioning integrity; a range of a value of Integrity Risk (IR) corresponding to the at least one type of assistance information; a residual risk corresponding to the at least one type of assistance information; parameters for determining the residual risk corresponding to the at least one type of assistance information; or a DNU flag associated with the at least one type of assistance information.

In some embodiments, the first node is a first anchor terminal, and the at least one type of assistance information includes: a statistical value of a position error of the first anchor terminal; and/or a statistical value of a position error of an antenna reference point of the first anchor terminal; wherein the statistical value includes at least one of: mean, variance, or standard deviation.

In some embodiments, when the positioning method adopted by the positioning system is a Time Difference of Arrival based positioning method, the at least one type of assistance information further includes: a statistical value of a Relative Time Difference (RTD) error of the first anchor terminal; or a statistical value of an RTD error of the first anchor terminal relative to a second anchor terminal; when the positioning method adopted by the positioning system is an Angle of Departure based positioning method, the at least one type of assistance information further includes: a statistical value of a beam angle error and/or a statistical value of antenna beam information for the first anchor terminal transmitting a Sidelink Positioning Reference Signal (SL-PRS); when the positioning method adopted by the positioning system is an Angle of Arrival based positioning method, the at least one type of assistance information further includes: a statistical value of a beam angle error and/or a statistical value of antenna beam information for the first anchor terminal receiving the SL-PRS; wherein the statistical value includes at least one of: mean, variance, or standard deviation.

In some embodiments, each piece of assistance information in the at least one type of assistance information corresponds to a first error source; the parameters for determining the residual risk corresponding to the at least one type of assistance information include: a probability of occurrence per unit time of a Feared Event corresponding to each first error source, and an expected average duration of the Feared Event corresponding to each first error source.

In some embodiments, for any piece of assistance information in the at least one type of assistance information, when the piece of assistance information cannot be used for applications related to the positioning integrity, the DNU flag associated with the piece of assistance information is set to a true value; when the piece of assistance information can be used for applications related to the positioning integrity, the DNU flag associated with the piece of assistance information is set to a false value.

In some embodiments, the first information further includes at least one of: information of at least one type of positioning measurement result obtained by the first node measuring SL-PRS, wherein all or part of the information of the at least one type of positioning measurement result is used to determine the positioning integrity; a range of a value of IR corresponding to the at least one type of positioning measurement result; a residual risk corresponding to the at least one type of positioning measurement result; parameters for determining the residual risk corresponding to the at least one type of positioning measurement result; or a DNU flag associated with the at least one type of positioning measurement result.

In some embodiments, the apparatus 500 further includes: a first transmitting unit, configured to, before receiving the first information from the first node via SLPP, transmit a Time-to-Alert (TTA) of the positioning system to the first node via SLPP, the TTA being used to determine: a DNU flag associated with the at least one type of assistance information; and/or a DNU flag associated with at least one type of positioning measurement result; wherein the at least one type of positioning measurement result is obtained by the first node measuring SL-PRS.

In some embodiments, the first information includes at least one of: information of at least one type of positioning measurement result obtained by a first node measuring SL-PRS, wherein all or part of the information of the at least one type of positioning measurement result is used to determine the positioning integrity; a range of a value of IR corresponding to the at least one type of positioning measurement result; a residual risk corresponding to the at least one type of positioning measurement result; parameters for determining the residual risk corresponding to the at least one type of positioning measurement result; or a DNU flag associated with the at least one type of positioning measurement result.

In some embodiments, each positioning measurement result in the at least one type of positioning measurement result corresponds to a second error source; the parameters for determining the residual risk corresponding to the at least one type of positioning measurement result include: a probability of occurrence per unit time of a Feared Event corresponding to each second error source, and an expected average duration of the Feared Event corresponding to each second error source.

In some embodiments, for any positioning measurement result in the at least one type of positioning measurement result, when the information of the positioning measurement result cannot be used for applications related to the positioning integrity, the DNU flag associated with the positioning measurement result is set to a true value; when the information of the positioning measurement result can be used for applications related to the positioning integrity, the DNU flag associated with the positioning measurement result is set to a false value.

In some embodiments, the information of the at least one type of positioning measurement result includes: a statistical value of an error of each positioning measurement result in the at least one type of positioning measurement result; the statistical value includes at least one of: mean, variance, or standard deviation.

In some embodiments, the first information includes at least one key performance indicator related to the positioning integrity: a Target Integrity Risk (TIR) of the positioning system; an Alert Limit (AL) of the positioning system; and a Time-to-Alert (TTA) of the positioning system.

In some embodiments, when the second node is a node for determining the positioning integrity, the first information includes: the TIR of the positioning system; and/or the AL of the positioning system; when the second node is a node for determining a DNU flag, the first information includes: the TTA of the positioning system.

In some embodiments, the second node is a Location Management Function network element or a Location Server UE, and the first information includes at least one of: a Protection Level (PL) of the positioning system; an achievable integrity risk of the positioning system; a comparison result between the PL of the positioning system and the AL of the positioning system, the comparison result being used to determine whether a positioning result of the positioning system meets positioning integrity requirements; or first indication information for indicating whether the positioning result of the positioning system meets positioning integrity requirements.

In some embodiments, the second node is a Location Management Function network element or a Location Server UE, when the first node transmits the first information using a first mode, the first information includes: the PL of the positioning system, and/or the achievable integrity risk of the positioning system; when the first node transmits the first information using a second mode, the first information includes at least one of: the comparison result between the PL of the positioning system and the AL of the positioning system; the first indication information for indicating whether the positioning result of the positioning system meets positioning integrity requirements; or the achievable integrity risk of the positioning system.

In some embodiments, the apparatus 500 further includes: a second transmitting unit, configured to, before receiving the first information from the first node via SLPP, transmit second indication information to the first node, the second indication information being used to instruct the first node to transmit the first information using the first mode or the second mode.

In some embodiments, when the PL of the positioning system is greater than the AL of the positioning system, the first information includes the comparison result and/or the first indication information; when the PL of the positioning system is less than the AL of the positioning system, the first information includes the comparison result and/or the first indication information; when the PL of the positioning system is less than the AL of the positioning system, or the PL of the positioning system is greater than the AL of the positioning system, the first information includes the comparison result and/or the first indication information.

Persons skilled in the art should understand that the relevant descriptions of the above communication apparatus in the embodiments of the present disclosure can be understood by referring to the relevant descriptions of the communication method in the embodiments of the present disclosure.

FIG. 6 is a schematic structural diagram of a communication device 600 provided by an embodiment of the present disclosure. The communication device 600 shown in FIG. 6 includes a processor 610. The processor 610 can invoke and run a computer program from a memory to implement the method in the embodiments of the present disclosure.

Optionally, as shown in FIG. 6, the communication device 600 may further include a memory 620. The processor 610 can invoke and run a computer program from the memory 620 to implement the method in the embodiments of the present disclosure.

Here, the memory 620 may be a separate device independent of the processor 610, or may be integrated into the processor 610.

Optionally, as shown in FIG. 6, the communication device 600 may further include a transceiver 630. The processor 610 may control the transceiver 630 to communicate with other devices. Specifically, it may send information or data to other devices, or receive information or data sent by other devices.

Here, the transceiver 630 may include a transmitter and a receiver. The transceiver 630 may further include one or more antennas.

Optionally, the communication device 600 may specifically be the first node in the embodiments of the present disclosure, and the communication device 600 may implement the corresponding processes implemented by the first node in the various methods of the embodiments of the present disclosure. For brevity, details are not repeated here.

Optionally, the communication device 600 may specifically be the second node in the embodiments of the present disclosure, and the communication device 600 may implement the corresponding processes implemented by the second node in the various methods of the embodiments of the present disclosure. For brevity, details are not repeated here.

FIG. 7 is a schematic structural diagram of a chip according to an embodiment of the present disclosure. The chip 700 shown in FIG. 7 includes a processor 710. The processor 710 can invoke and run a computer program from a memory to implement the method in the embodiments of the present disclosure.

Optionally, as shown in FIG. 7, the chip 700 may further include a memory 720. The processor 710 can invoke and run a computer program from the memory 720 to implement the method in the embodiments of the present disclosure.

Here, the memory 720 may be a separate device independent of the processor 710, or may be integrated into the processor 710.

Optionally, the chip 700 may further include an input interface 730. The processor 710 may control the input interface 730 to communicate with other devices or chips, specifically, to obtain information or data sent by other devices or chips.

Optionally, the chip 700 may further include an output interface 740. The processor 710 may control the output interface 740 to communicate with other devices or chips, specifically, to output information or data to other devices or chips.

Optionally, the chip may be applied to the first node in the embodiments of the present disclosure, and the chip may implement the corresponding processes implemented by the first node in the various methods of the embodiments of the present disclosure. For brevity, details are not repeated here.

Optionally, the chip may be applied to the second node in the embodiments of the present disclosure, and the chip may implement the corresponding processes implemented by the second node in the various methods of the embodiments of the present disclosure. For brevity, details are not repeated here.

It should be understood that the chip mentioned in the embodiments of the present disclosure may also be referred to as a system-on-chip, system chip, chip system, or system-on-a-chip, etc.

It should be understood that the processor in the embodiments of the present disclosure may be an integrated circuit chip with signal processing capability. In the implementation process, the steps of the above method embodiments may be completed by integrated logic circuits of hardware in the processor or instructions in the form of software. The above processor may be a general-purpose processor, a Digital Signal Processor (DSP), an Application Specific Integrated Circuit (ASIC), a Field Programmable Gate Array (FPGA) or other programmable logic device, discrete gate or transistor logic device, or discrete hardware component. It may implement or perform the methods, steps, and logic block diagrams disclosed in the embodiments of the present disclosure. The general-purpose processor may be a microprocessor or any conventional processor, etc. The steps of the methods disclosed in the embodiments of the present disclosure may be directly embodied as being executed and completed by a hardware decoding processor, or executed and completed by a combination of hardware and software modules in the decoding processor. The software module may be located in a mature storage medium in the art such as random access memory, flash memory, read-only memory, programmable read-only memory, electrically erasable programmable memory, or registers. The storage medium is located in the memory, and the processor reads information in the memory and completes the steps of the above methods in combination with its hardware.

It can be understood that the memory in the embodiments of the present disclosure may be a volatile memory or a non-volatile memory, or may include both volatile and non-volatile memory. The non-volatile memory may be Read-Only Memory (ROM), Programmable ROM (PROM), Erasable PROM (EPROM), Electrically EPROM (EEPROM), or flash memory. The volatile memory may be Random Access Memory (RAM), which is used as an external cache. By way of example but not limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DR RAM). It should be noted that the memory of the systems and methods described herein is intended to include, but is not limited to, these and any other suitable types of memory.

It should be understood that the above description of the memory is exemplary but not limiting. For example, the memory in the embodiments of the present disclosure may also be Static RAM (SRAM), Dynamic RAM (DRAM), Synchronous DRAM (SDRAM), Double Data Rate SDRAM (DDR SDRAM), Enhanced SDRAM (ESDRAM), Synch Link DRAM (SLDRAM), Direct Rambus RAM (DR RAM), etc. That is to say, the memory in the embodiments of the present disclosure is intended to include, but is not limited to, these and any other suitable types of memory.

The embodiments of the present disclosure also provide a computer-readable storage medium for storing computer programs.

Optionally, the computer-readable storage medium may be applied to the first node in the embodiments of the present disclosure, and the computer program causes a computer to execute the corresponding processes implemented by the first node in the various methods of the embodiments of the present disclosure. For brevity, details are not repeated here.

Optionally, the computer-readable storage medium may be applied to the second node in the embodiments of the present disclosure, and the computer program causes a computer to execute the corresponding processes implemented by the second node in the various methods of the embodiments of the present disclosure. For brevity, details are not repeated here.

The embodiments of the present disclosure also provide a computer program product including computer program instructions.

Optionally, the computer program product may be applied to the first node in the embodiments of the present disclosure, and the computer program instructions cause a computer to execute the corresponding processes implemented by the first node in the various methods of the embodiments of the present disclosure. For brevity, details are not repeated here.

Optionally, the computer program product may be applied to the second node in the embodiments of the present disclosure, and the computer program instructions cause a computer to execute the corresponding processes implemented by the second node in the various methods of the embodiments of the present disclosure. For brevity, details are not repeated here.

The embodiments of the present disclosure also provide a computer program.

Optionally, the computer program may be applied to the first node in the embodiments of the present disclosure. When the computer program is run on a computer, it causes the computer to execute the corresponding processes implemented by the first node in the various methods of the embodiments of the present disclosure. For brevity, details are not repeated here.

Optionally, the computer program may be applied to the second node in the embodiments of the present disclosure. When the computer program is run on a computer, it causes the computer to execute the corresponding processes implemented by the second node in the various methods of the embodiments of the present disclosure. For brevity, details are not repeated here.

A person of ordinary skill in the art may be aware that, in combination with the examples described in the embodiments disclosed herein, units and algorithm steps may be implemented by electronic hardware, or a combination of computer software and electronic hardware. Whether these functions are performed by hardware or software depends on the specific application and design constraints of the technical solution. Professionals may use different methods for each specific application to implement the described functions, but such implementation should not be considered beyond the scope of the present disclosure.

Persons skilled in the art may clearly understand that, for the convenience and brevity of description, the specific working processes of the systems, apparatuses, and units described above may refer to the corresponding processes in the foregoing method embodiments and will not be repeated here.

In the several embodiments provided in the present disclosure, it should be understood that the disclosed systems, apparatuses, and methods may be implemented in other ways. For example, the apparatus embodiments described above are merely illustrative. For example, the division of units is only a logical function division. In actual implementation, there may be other division methods. For example, multiple units or components may be combined or integrated into another system, or some features may be omitted or not executed. In addition, the mutual coupling or direct coupling or communication connection shown or discussed may be indirect coupling or communication connection through some interfaces, apparatuses, or units, and may be in electrical, mechanical, or other forms.

The units described as separate components may or may not be physically separate, and the components displayed as units may or may not be physical units, that is, may be located in one place, or may be distributed over multiple network units. Some or all of the units may be selected according to actual needs to achieve the objectives of the solutions of the embodiments.

In addition, the functional units in the various embodiments of the present disclosure may be integrated into one processing unit, or each unit may exist physically separately, or two or more units may be integrated into one unit.

If the functions are implemented in the form of software functional units and sold or used as independent products, they may be stored in a computer-readable storage medium. Based on such understanding, the technical solutions of the present disclosure, in essence, or the part contributing to the prior art, or part of the technical solutions, may be embodied in the form of a software product. The computer software product is stored in a storage medium and includes several instructions for causing a computer device (which may be a personal computer, a server, or a network device, etc.) to perform all or part of the steps of the methods described in the various embodiments of the present disclosure. The foregoing storage medium includes: U disk, mobile hard disk, Read-Only Memory (ROM), Random Access Memory (RAM), magnetic disk, or optical disk, and other media that can store program codes.

The above are only specific implementations of the present disclosure, but the protection scope of the present disclosure is not limited thereto. Any person skilled in the art can easily think of changes or substitutions within the technical scope disclosed in the present disclosure, which should be covered within the protection scope of the present disclosure. Therefore, the protection scope of the present disclosure shall be subject to the protection scope of the claims.

1. A communication method, applied to a first node, the method comprising:
transmitting first information to a second node via a Sidelink Positioning Protocol (SLPP), the first information being related to positioning integrity of a positioning system.

2. The communication method according to claim 1, wherein the first information comprises at least one of:
at least one type of assistance information, wherein all or part of the at least one type of assistance information is used to determine the positioning integrity;
a range of a value of Integrity Risk (IR) corresponding to the at least one type of assistance information;
a residual risk corresponding to the at least one type of assistance information;
parameters for determining the residual risk corresponding to the at least one type of assistance information; or
a Do Not Use (DNU) flag associated with the at least one type of assistance information, wherein the first node is a first anchor terminal, and the at least one type of assistance information comprises:
a statistical value of a position error of the first anchor terminal; and/or
a statistical value of a position error of an antenna reference point of the first anchor terminal;
wherein the statistical value comprises at least one of: mean, variance, or standard deviation,
wherein
when a positioning method adopted by the positioning system is a Time Difference of Arrival based positioning method, the at least one type of assistance information further comprises: a statistical value of a Relative Time Difference (RTD) error of the first anchor terminal; or a statistical value of an RTD error of the first anchor terminal relative to a second anchor terminal;
when the positioning method adopted by the positioning system is an Angle of Departure based positioning method, the at least one type of assistance information further comprises: a statistical value of a beam angle error and/or a statistical value of antenna beam information for the first anchor terminal transmitting a Sidelink Positioning Reference Signal (SL-PRS);
when the positioning method adopted by the positioning system is an Angle of Arrival based positioning method, the at least one type of assistance information further comprises: a statistical value of a beam angle error and/or a statistical value of antenna beam information for the first anchor terminal receiving the SL-PRS,
wherein the statistical value comprises at least one of: mean, variance, or standard deviation.

3. The communication method according to claim 2, wherein each piece of assistance information in the at least one type of assistance information corresponds to a first error source;
the parameters for determining the residual risk corresponding to the at least one type of assistance information comprise:
a probability of occurrence per unit time of a Feared Event corresponding to each first error source, and an expected average duration of the Feared Event corresponding to each first error source,
wherein for any piece of assistance information in the at least one type of assistance information,
when the piece of assistance information cannot be used for applications related to the positioning integrity, a Do Not Use (DNU) flag associated with the piece of assistance information is set to a true value;
when the piece of assistance information can be used for applications related to the positioning integrity, the DNU flag associated with the piece of assistance information is set to a false value,
wherein the first information further comprises at least one of:
information of at least one type of positioning measurement result obtained by the first node measuring SL-PRS, wherein all or part of the information of the at least one type of positioning measurement result is used to determine the positioning integrity;
a range of a value of IR corresponding to the at least one type of positioning measurement result;
a residual risk corresponding to the at least one type of positioning measurement result;
parameters for determining the residual risk corresponding to the at least one type of positioning measurement result; or
a Do Not Use (DNU) flag associated with the at least one type of positioning measurement result,
wherein before transmitting the first information to the second node via the SLPP, the method further comprises:
receiving a Time-to-Alert (TTA) of the positioning system via the SLPP, the TTA being used to determine:
a Do Not Use (DNU) flag associated with the at least one type of assistance information; and/or
a DNU flag associated with at least one type of positioning measurement result,
wherein the at least one type of positioning measurement result is obtained by the first node measuring the SL-PRS.

4. The communication method according to claim 1, wherein the first information comprises at least one of:
information of at least one type of positioning measurement result obtained by the first node measuring the SL-PRS, wherein all or part of the information of the at least one type of positioning measurement result is used to determine the positioning integrity;
a range of a value of IR corresponding to the at least one type of positioning measurement result;
a residual risk corresponding to the at least one type of positioning measurement result;
parameters for determining the residual risk corresponding to the at least one type of positioning measurement result; or
a Do Not Use (DNU) flag associated with the at least one type of positioning measurement result,
wherein each positioning measurement result in the at least one type of positioning measurement result corresponds to a second error source;
the parameters for determining the residual risk corresponding to the at least one type of positioning measurement result comprise:
a probability of occurrence per unit time of a Feared Event corresponding to each second error source, and an expected average duration of the Feared Event corresponding to each second error source,
wherein for any positioning measurement result in the at least one type of positioning measurement result,
when the information of the positioning measurement result cannot be used for applications related to the positioning integrity, a Do Not Use (DNU) flag associated with the positioning measurement result is set to a true value;
when the information of the positioning measurement result can be used for applications related to the positioning integrity, the DNU flag associated with the positioning measurement result is set to a false value.

5. The communication method according to claim 1, wherein the first information comprises at least one of the key performance indicators related to the positioning integrity, the key performance indicators comprising:
a Target Integrity Risk (TIR) of the positioning system;
an Alert Limit (AL) of the positioning system; and
a Time-to-Alert (TTA) of the positioning system,
wherein
when the second node is a node for determining the positioning integrity, the first information comprises: the TIR of the positioning system; and/or the AL of the positioning system;
when the second node is a node for determining a Do Not Use (DNU) flag, the first information comprises: the TTA of the positioning system.

6. The communication method according to claim 1, wherein the second node is a Location Management Function network element or a Location Server User Equipment (UE), and the first information comprises at least one of:
a Protection Level (PL) of the positioning system;
an achievable integrity risk of the positioning system;
a comparison result between the PL of the positioning system and an Alert Limit (AL) of the positioning system, the comparison result being used to determine whether a positioning result of the positioning system meets positioning integrity requirements; or
first indication information for indicating whether the positioning result of the positioning system meets positioning integrity requirements.

7. The communication method according to claim 1, wherein the second node is a Location Management Function network element or a Location Server UE,
when the first node transmits the first information using a first mode, the first information comprises:
a Protection Level (PL) of the positioning system, and/or an achievable integrity risk of the positioning system;
when the first node transmits the first information using a second mode, the first information comprises at least one of:
a comparison result between the PL of the positioning system and an Alert Limit (AL) of the positioning system;
first indication information for indicating whether a positioning result of the positioning system meets positioning integrity requirements; and
the achievable integrity risk of the positioning system,
wherein before transmitting the first information to the second node via the SLPP, the method further comprises:
receiving second indication information from the second node, the second indication information being used to instruct the first node to transmit the first information using the first mode or the second mode.

8. A communication method, applied to a second node, the method comprising:
receiving first information from a first node via a Sidelink Positioning Protocol (SLPP), the first information being related to positioning integrity of a positioning system.

9. The communication method according to claim 8, wherein the first information comprises at least one of:
at least one type of assistance information, wherein all or part of the at least one type of assistance information is used to determine the positioning integrity;
a range of a value of Integrity Risk (IR) corresponding to the at least one type of assistance information;
a residual risk corresponding to the at least one type of assistance information;
parameters for determining the residual risk corresponding to the at least one type of assistance information; and
a Do Not Use (DNU) flag associated with the at least one type of assistance information,
wherein the first node is a first anchor terminal, and the at least one type of assistance information comprises:
a statistical value of a position error of the first anchor terminal; and/or
a statistical value of a position error of an antenna reference point of the first anchor terminal,
wherein the statistical value comprises at least one of: mean, variance, or standard deviation,
wherein
when a positioning method adopted by the positioning system is a Time Difference of Arrival based positioning method, the at least one type of assistance information further comprises: a statistical value of a Relative Time Difference (RTD) error of the first anchor terminal; or a statistical value of an RTD error of the first anchor terminal relative to a second anchor terminal; or
when the positioning method adopted by the positioning system is an Angle of Departure based positioning method, the at least one type of assistance information further comprises: a statistical value of a beam angle error and/or a statistical value of antenna beam information for the first anchor terminal transmitting a Sidelink Positioning Reference Signal (SL-PRS); or
when the positioning method adopted by the positioning system is an Angle of Arrival based positioning method, the at least one type of assistance information further comprises: a statistical value of a beam angle error and/or a statistical value of antenna beam information for the first anchor terminal receiving the SL-PRS,
wherein the statistical value comprises at least one of: mean, variance, or standard deviation.

10. The communication method according to claim 9, wherein each piece of assistance information in the at least one type of assistance information corresponds to a first error source;
the parameters for determining the residual risk corresponding to the at least one type of assistance information comprise:
a probability of occurrence per unit time of a Feared Event corresponding to each first error source, and an expected average duration of the Feared Event corresponding to each first error source,
wherein for any piece of assistance information in the at least one type of assistance information,
when the piece of assistance information cannot be used for applications related to the positioning integrity, a Do Not Use (DNU) flag associated with the piece of assistance information is set to a true value;
when the piece of assistance information can be used for applications related to the positioning integrity, the DNU flag associated with the piece of assistance information is set to a false value,
wherein the first information further comprises at least one of:
information of at least one type of positioning measurement result obtained by the first node measuring SL-PRS, wherein all or part of the information of the at least one type of positioning measurement result is used to determine the positioning integrity;
a range of a value of IR corresponding to the at least one type of positioning measurement result;
a residual risk corresponding to the at least one type of positioning measurement result;
parameters for determining the residual risk corresponding to the at least one type of positioning measurement result; and
a Do Not Use (DNU) flag associated with the at least one type of positioning measurement result,
wherein before receiving the first information from the first node via the SLPP, the method further comprises:
transmitting a Time-to-Alert (TTA) of the positioning system to the first node via the SLPP, the TTA being used to determine:
a Do Not Use (DNU) flag associated with the at least one type of assistance information; and/or
a DNU flag associated with at least one type of positioning measurement result;
wherein the at least one type of positioning measurement result is obtained by the first node measuring SL-PRS.

11. The communication method according to claim 8, wherein the first information comprises at least one of:
information of at least one type of positioning measurement result obtained by the first node measuring SL-PRS, wherein all or part of the information of the at least one type of positioning measurement result is used to determine the positioning integrity;
a range of a value of IR corresponding to the at least one type of positioning measurement result;
a residual risk corresponding to the at least one type of positioning measurement result;
parameters for determining the residual risk corresponding to the at least one type of positioning measurement result; and
a Do Not Use (DNU) flag associated with the at least one type of positioning measurement result,
wherein each positioning measurement result in the at least one type of positioning measurement result corresponds to a second error source;
the parameters for determining the residual risk corresponding to the at least one type of positioning measurement result comprise:
a probability of occurrence per unit time of a Feared Event corresponding to each second error source, and an expected average duration of the Feared Event corresponding to each second error source.

12. The communication method according to claim 10, wherein for any positioning measurement result in the at least one type of positioning measurement result,
when the information of the positioning measurement result cannot be used for applications related to the positioning integrity, a Do Not Use (DNU) flag associated with the positioning measurement result is set to a true value;
when the information of the positioning measurement result can be used for applications related to the positioning integrity, the DNU flag associated with the positioning measurement result is set to a false value,
wherein the information of the at least one type of positioning measurement result comprises:
a statistical value of an error of each positioning measurement result in the at least one type of positioning measurement result, wherein the statistical value comprises at least one of: mean, variance, or standard deviation.

13. The communication method according to claim 8, wherein the first information comprises at least one of key performance indicators related to the positioning integrity, the key performance indicators comprising:
a Target Integrity Risk (TIR) of the positioning system;
an Alert Limit (AL) of the positioning system; and
a Time-to-Alert (TTA) of the positioning system,
wherein
when the second node is a node for determining the positioning integrity, the first information comprises: the TIR of the positioning system; and/or the AL of the positioning system;
when the second node is a node for determining a Do Not Use (DNU) flag, the first information comprises: the TTA of the positioning system.

14. A first node, comprising:
a processor and a memory, the memory being configured to store a computer program, the processor being configured to invoke and run the computer program stored in the memory to control the first node to:
transmit first information to a second node via a Sidelink Positioning Protocol (SLPP), the first information being related to positioning integrity of a positioning system.

15. The first node according to claim 14, wherein the first information comprises at least one of:
at least one type of assistance information, wherein all or part of the at least one type of assistance information is used to determine the positioning integrity;
a range of a value of Integrity Risk (IR) corresponding to the at least one type of assistance information;
a residual risk corresponding to the at least one type of assistance information;
parameters for determining the residual risk corresponding to the at least one type of assistance information; or
a Do Not Use (DNU) flag associated with the at least one type of assistance information, wherein the first node is a first anchor terminal, and the at least one type of assistance information comprises:
a statistical value of a position error of the first anchor terminal; and/or
a statistical value of a position error of an antenna reference point of the first anchor terminal;
wherein the statistical value comprises at least one of: mean, variance, or standard deviation,
wherein
when a positioning method adopted by the positioning system is a Time Difference of Arrival based positioning method, the at least one type of assistance information further comprises: a statistical value of a Relative Time Difference (RTD) error of the first anchor terminal; or a statistical value of an RTD error of the first anchor terminal relative to a second anchor terminal; or
when the positioning method adopted by the positioning system is an Angle of Departure based positioning method, the at least one type of assistance information further comprises: a statistical value of a beam angle error and/or a statistical value of antenna beam information for the first anchor terminal transmitting a Sidelink Positioning Reference Signal (SL-PRS); or
when the positioning method adopted by the positioning system is an Angle of Arrival based positioning method, the at least one type of assistance information further comprises: a statistical value of a beam angle error and/or a statistical value of antenna beam information for the first anchor terminal receiving the SL-PRS,
wherein the statistical value comprises at least one of: mean, variance, or standard deviation.

16. The first node according to claim 15, wherein each piece of assistance information in the at least one type of assistance information corresponds to a first error source;
the parameters for determining the residual risk corresponding to the at least one type of assistance information comprise:
a probability of occurrence per unit time of a Feared Event corresponding to each first error source, and an expected average duration of the Feared Event corresponding to each first error source,
wherein for any piece of assistance information in the at least one type of assistance information,
when the piece of assistance information cannot be used for applications related to the positioning integrity, a Do Not Use (DNU) flag associated with the piece of assistance information is set to a true value;
when the piece of assistance information can be used for applications related to the positioning integrity, the DNU flag associated with the piece of assistance information is set to a false value,
wherein the first information further comprises at least one of:
information of at least one type of positioning measurement result obtained by the first node measuring SL-PRS, wherein all or part of the information of the at least one type of positioning measurement result is used to determine the positioning integrity;
a range of a value of IR corresponding to the at least one type of positioning measurement result;
a residual risk corresponding to the at least one type of positioning measurement result;
parameters for determining the residual risk corresponding to the at least one type of positioning measurement result; or
a Do Not Use (DNU) flag associated with the at least one type of positioning measurement result,
wherein the processor is further configured to invoke and run the computer program to control the first not to: before transmitting the first information to the second node via the SLPP, receive a Time-to-Alert (TTA) of the positioning system via the SLPP, the TTA being used to determine:
a Do Not Use (DNU) flag associated with the at least one type of assistance information; and/or
a DNU flag associated with at least one type of positioning measurement result,
wherein the at least one type of positioning measurement result is obtained by the first node measuring the SL-PRS.

17. The first node according to claim 14, wherein the first information comprises at least one of:
information of at least one type of positioning measurement result obtained by the first node measuring the SL-PRS, wherein all or part of the information of the at least one type of positioning measurement result is used to determine the positioning integrity;
a range of a value of IR corresponding to the at least one type of positioning measurement result;
a residual risk corresponding to the at least one type of positioning measurement result;
parameters for determining the residual risk corresponding to the at least one type of positioning measurement result; or
a Do Not Use (DNU) flag associated with the at least one type of positioning measurement result,
wherein each positioning measurement result in the at least one type of positioning measurement result corresponds to a second error source;
the parameters for determining the residual risk corresponding to the at least one type of positioning measurement result comprise:
a probability of occurrence per unit time of a Feared Event corresponding to each second error source, and an expected average duration of the Feared Event corresponding to each second error source,
wherein for any positioning measurement result in the at least one type of positioning measurement result,
when the information of the positioning measurement result cannot be used for applications related to the positioning integrity, a Do Not Use (DNU) flag associated with the positioning measurement result is set to a true value;
when the information of the positioning measurement result can be used for applications related to the positioning integrity, the DNU flag associated with the positioning measurement result is set to a false value.

18. The first node according to claim 14, wherein the first information comprises at least one of the key performance indicators related to the positioning integrity, the key performance indicators comprising:
a Target Integrity Risk (TIR) of the positioning system;
an Alert Limit (AL) of the positioning system; and
a Time-to-Alert (TTA) of the positioning system,
wherein
when the second node is a node for determining the positioning integrity, the first information comprises: the TIR of the positioning system; and/or the AL of the positioning system;
when the second node is a node for determining a Do Not Use (DNU) flag, the first information comprises: the TTA of the positioning system.

19. The first node according to claim 14, wherein the second node is a Location Management Function network element or a Location Server User Equipment (UE), and the first information comprises at least one of:
a Protection Level (PL) of the positioning system;
an achievable integrity risk of the positioning system;
a comparison result between the PL of the positioning system and an Alert Limit (AL) of the positioning system, the comparison result being used to determine whether a positioning result of the positioning system meets positioning integrity requirements; or
first indication information for indicating whether the positioning result of the positioning system meets positioning integrity requirements.

20. The first node according to claim 14, wherein the second node is a Location Management Function network element or a Location Server UE,
when the first node transmits the first information using a first mode, the first information comprises:
a Protection Level (PL) of the positioning system, and/or an achievable integrity risk of the positioning system;
when the first node transmits the first information using a second mode, the first information comprises at least one of:
a comparison result between the PL of the positioning system and an Alert Limit (AL) of the positioning system;
first indication information for indicating whether a positioning result of the positioning system meets positioning integrity requirements; and
the achievable integrity risk of the positioning system,
wherein the processor is further configured to invoke and run the computer program stored in the memory to control the first node to: before transmitting the first information to the second node via the SLPP, receive second indication information from the second node, the second indication information being used to instruct the first node to transmit the first information using the first mode or the second mode.
